(19) United States
(12) Patent Application Publication
(10) Pub. No.: US 2024/0310560 A1
(43) Pub. Date: Sep. 19, 2024

(54) SCREEN PROTECTORS TAILORED FOR ELECTRONIC DEVICE DISPLAYS

(71) Applicant: CORNING INCORPORATED, CORNING, NY (US)

(72) Inventors: Sean Michael Buono, Horseheads, NY (US); Shandon Dee Hart, Elmira, NY (US); Karl William Koch, III, Elmira, NY (US); Carlo Anthony Kosik Williams, Painted Post, NY (US); Lin Lin, Painted Post, NY (US); Alexandre Michel Mayolet, Corning, NY (US); Eric Louis Null, Corning, NY (US); Ananthanarayanan Subramanian, Corning, NY (US); Wenlei Zhang, Big Flats, NY (US)

(21) Appl. No.: 18/602,303

(22) Filed: Mar. 12, 2024

Related U.S. Application Data
(60) Provisional application No. 63/601,349, filed on Nov. 21, 2023.
(60) Provisional application No. 63/452,722, filed on Mar. 17, 2023.

(51) Int. Cl. G02B 1/115

(52) U.S. Cl. CPC G02B 1/115

(57) ABSTRACT

A screen protector is described herein that is configured to be releasably attached to an optical coating on a glass-containing display of an electronic device. The protector comprises: a glass-containing substrate comprising an outer and inner primary surface; an antireflective (AR) coating on the outer primary surface; and an interlayer on the inner primary surface for releasable attachment to the optical coating on the display. The interlayer comprises an adhesive, a physical thickness from about 10 μm to 500 μm, and one or more refractive indices from ˜1.2 to 1.6. Further, an average photopic reflectance of the screen protector can be less than 2% for all incident angles from 0° to 30°. The interlayer can comprise optically clear adhesive (OCA), polymer-containing layer, and releasable adhesive layers. An anti-splinter (AS) film can be between the interlayer and the substrate. The interlayer and/or AS film may be a cyclo olefin, cellulose triacetate or polyurethane.

### CLAIM OF PRIORITY

This application claims the benefit of priority under 35 U.S.C. § 119 of U.S. Provisional Application No. 63/601,349 filed Nov. 21, 2023 and claims the benefit of priority under 35 U.S.C. § 119 of U.S. Provisional Application No. 63/452,722 filed Mar. 17, 2023. The entire contents of each of these applications are hereby incorporated herein by reference for all purposes.

### FIELD OF THE DISCLOSURE

The disclosure relates to screen protectors with AR coatings for electronic device displays that possess their own AR coating and, in some cases, an anti-splinter (AS) film, and articles that include AR display devices and such AR screen protectors.

### BACKGROUND

Optical interference coatings consisting of thin films are commonly used to modify the reflectance spectrum of a display substrate. For display devices, lower reflectance is necessary to achieve higher contrast ratio, larger color gamut, and other desirable optical performance characteristics. Recently, multilayer antireflection (AR) coatings have been successfully used on display substrates in various display devices (e.g., on consumer mobile phone cover glass) to reduce reflectance. Further, some of these AR coatings have been successfully configured to enhance the scratch resistance of these display devices.

The user of these display devices will sometimes apply a screen protector, which may have its own AR coating (e.g., OtterBox® Amplify Glass) or may only be configured for a mechanical function (e.g., scratch and drop resistance). The screen protector may also incorporate an anti-splinter (AS) film to retain shards of the protector upon inadvertent breakage. Typically, these users are motivated to add a screen protector to their electronic display devices to enhance the mechanical performance of the device (e.g., drop and/or scratch resistance). In any of these scenarios, it is apparent that the combination of a screen protector, with an AR coating and possibly an AS film, and a display with or without an AR coating can produce undesirable or unintended optical effects, e.g., degraded reflectance and/or contrast ratio.

Accordingly, there is a need for screen protectors, with an AR coating and, in some cases, an additional AS film, that are tailored for electronic device displays that possess their own AR coating to reduce or minimize degradation in reflectance and/or contrast ratio; and cover articles that include AR display devices and AR screen protectors tailored to them to reduce or minimize such degradation. This need and other needs are addressed by the present disclosure.

### SUMMARY

Generally, the disclosure is directed to screen protectors with AR coatings for electronic device displays that possess their own AR coating, and articles that include AR display devices and AR screen protectors. The disclosed screen protectors employ an AR coating disposed on a substrate (e.g., a glass substrate, Corning® Gorilla Glass® products, etc.), and an interlayer with an adhesive disposed on the substrate for releasable attachment to an optical coating (e.g., an AR coating) disposed on a glass-containing display of an electronic device. The interlayer can have one or more refractive indices, each ranging from about 1.2 to about 1.6. Further, the average photopic reflectance of the screen protector, as releasably attached to the display, is less than 2% for all incident angles from 0° to 30°.

According to an aspect of the disclosure, a screen protector is configured to be releasably attached to an optical coating disposed on a glass-containing display of an electronic device. The screen protector includes: a glass-containing substrate comprising an outer primary surface and an inner primary surface, wherein the inner primary surface is opposite from the outer primary surface; an antireflective (AR) coating disposed on the outer primary surface of the glass-containing substrate; and an interlayer disposed on the inner primary surface of the glass-containing substrate. The interlayer is configured for releasable attachment to the optical coating disposed on the glass-containing display of the electronic device. The interlayer comprises an adhesive and has a physical thickness from about 10 μm to 500 μm. The interlayer has one or more refractive indices, and each refractive index of the interlayer is from about 1.2 to about 1.6. Further, an average photopic reflectance of the screen protector which is releasably attached to the optical coating of the glass-containing display is less than 2% for all incident angles from 0° to 30°. This aspect can serve as a screen protector that is tailored for an electronic device with a glass-containing display and AR coating to minimize or otherwise reduce the reflectance of the combined article.

According to an aspect of the disclosure, a screen protector is provided that includes: a glass-containing substrate comprising an outer primary surface and an inner primary surface, wherein the inner primary surface is opposite from the outer primary surface; an antireflective (AR) coating disposed on the outer primary surface of the glass-containing substrate; and an interlayer disposed on the inner primary surface of the glass-containing substrate. The interlayer comprises an optically clear adhesive (OCA) layer disposed on the inner primary surface of the glass-containing substrate; a polymer-containing layer disposed on the OCA layer; and a releasable adhesive layer disposed on the polymer-containing layer. A total thickness of the OCA layer, the polymer-containing layer and the releasable adhesive layer is from about 10 μm to 500 μm. Further, each of the OCA layer, the polymer-containing layer and the releasable adhesive layer has a refractive index from about 1.2 to about 1.6. This aspect can serve as a screen protector that is tailored for an electronic device with a glass-containing display and AR coating to minimize or otherwise reduce the reflectance of the combined article.

According to an aspect of the disclosure, a screen protector is provided that includes: a glass-containing substrate comprising an outer primary surface and an inner primary surface, wherein the inner primary surface is opposite from the outer primary surface; an antireflective (AR) coating disposed on the outer primary surface of the glass-containing substrate; an anti-splinter (AS) film disposed on the inner primary surface of the glass-containing substrate; and an interlayer disposed on the AS film. The AS film comprises a first optically clear adhesive (OCA) layer disposed on the inner primary surface of the glass-containing substrate; and a first polymer-containing layer disposed on the first OCA layer. The interlayer comprises a second OCA layer disposed on the first polymer-containing layer; a second polymer-containing layer disposed on the second OCA layer; and a releasable adhesive layer disposed on the second polymer-containing layer. In some implementations of this aspect, a total thickness of the interlayer is from about 10 μm to 500 μm and a total physical thickness of the AS film is from about 50 μm to 150 μm. Further, according to some implementations of this aspect, each of the first and second polymer-containing layers, the first and second OCA layers, and the releasable adhesive layer has a refractive index from about 1.2 to about 1.6. This aspect can serve as a screen protector that is tailored for an electronic device with a glass-containing display and AR coating to minimize or otherwise reduce the reflectance and/or contrast ratio of the combined article.

According to an aspect of the disclosure, an article is provided that includes: an electronic device comprising an antireflective (AR) coating disposed on a glass-containing display; and a screen protector. The screen protector includes: a glass-containing substrate comprising an outer primary surface and an inner primary surface, wherein the inner primary surface is opposite from the outer primary surface; an AR coating disposed on the outer primary surface of the glass-containing substrate; and an interlayer disposed on the inner primary surface of the glass-containing substrate. The interlayer comprises an optically clear adhesive (OCA) layer disposed on the inner primary surface of the glass-containing substrate; a polymer-containing layer disposed on the OCA layer; and a releasable adhesive layer disposed on the polymer-containing layer. A total thickness of the OCA layer, the polymer-containing layer and the releasable adhesive layer is from about 10 μm to 500 μm. Further, each of the OCA layer, the polymer-containing layer and the releasable adhesive layer has a refractive index from about 1.2 to about 1.6. Further, the glass-containing substrate comprises a compressive stress region with a maximμm compressive stress (CS) of at least 600 MPa and defined from the outer primary surface to a depth. In addition, the releasable adhesive layer is configured for releasable attachment to the AR coating disposed on the glass-containing display of the electronic device. This aspect can serve as an article that includes an AR screen protector and an AR electronic device in which the AR screen protector is tailored to ensure that the article has a reduced or minimized reflectance.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIGS. 1, 1A, 1B, and 1C are cross-sectional side views of an article comprising an AR screen protector and an AR electronic device, according to one or more embodiments of the disclosure;

FIG. 1D is a schematic of an electronic device with an AR coating, according to one or more embodiments of the disclosure;

FIG. 1E is a schematic of an article comprising an AR screen protector as releasably attached to the electronic device of FIG. 1D, according to one or more embodiments of the disclosure;

FIG. 2A is a schematic of a three-layered material with distinct refractive indices, according to an embodiment of the disclosure;

FIG. 2B is a schematic plot of total reflectance vs. refractive index of the second layer of the three-layered material in the schematic of FIG. 2A;

FIGS. 3, 4, 5, and 6 are schematic plots of photopic reflectance as a function of incident angle for a comparative, bare electronic device with an AR coating and two articles comprising an electronic device with the same AR coating and a particular AR screen protector configuration with uniform interlayer elements, according to embodiments of the disclosure;

FIGS. 7, 8, 9, and 10 are schematic plots of photopic reflectance as a function of incident angle for a comparative, bare electronic device with an AR coating and two articles comprising an electronic device with the same AR coating and a particular AR screen protector configuration with interlayer elements having a graded refractive index, according to embodiments of the disclosure;

FIG. 11A is a bar graph showing the change in average photopic reflectance for the two articles of each of FIGS. 3-6;

FIG. 11B is a bar graph showing the change in average photopic reflectance for the two articles of each of FIGS. 7-10;

FIG. 12 is a bar graph showing the change in average photopic reflectance for two articles comprising an electronic device with an AR coating and a particular AR screen protector configuration with interlayer elements having a fully-optimized refractive index and interlayer elements having a partially-optimized refractive index, according to embodiments of the disclosure;

FIGS. 13A and 13B are plots of average photopic reflectance of an AR screen protector design disposed on an AR display and a comparative AR display as a function of the refractive index of the releasable adhesive layer of the interlayer of the screen protector, according to embodiments of the disclosure; and

FIG. 14 is a plot of contrast ratio (CR) as a function of display luminance for screen protector examples with an AR coating on one primary surface and an OCA layer/polymer-containing film sandwich on the other primary surface, as disposed on and measured with a mobile phone device, and for a bare phone device control, according to embodiments of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the term “dispose” includes coating, depositing, and/or forming a material onto a surface using any known or to be developed method in the art. The disposed material may constitute a layer, as defined herein. As used herein, the phrase “disposed on” includes forming a material onto a surface such that the material is in direct contact with the surface and embodiments where the material is formed on a surface with one or more intervening material(s) disposed between the material and the surface. The intervening material(s) may constitute a layer, as defined herein.

As used herein, the terms “low RI layer” and “high RI layer” refer to the relative values of the refractive index (“RI”) of layers of an AR coating of a screen protector and/or an electronic device according to the disclosure (i.e., low RI layer<high RI layer). Hence, low RI layers have refractive index values that are less than the refractive index values of high RI layers. Further, as used herein, “low RI layer” and “low index layer” are interchangeable with the same meaning. Likewise, “high RI layer” and “high index layer” are interchangeable with the same meaning.

As used herein, the term “strengthened substrate” refers to a substrate employed in a screen protector and/or electronic device of the disclosure that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

As used herein, the “Berkovich Indenter Hardness Test” and “Berkovich Hardness Test” are used interchangeably to refer to a test for measuring the hardness of a material on a surface thereof by indenting the surface with a diamond Berkovich indenter. The Berkovich Indenter Hardness Test includes indenting the outermost surface (e.g., an exposed surface) of an AR coating of a screen protector and/or an electronic device of the disclosure with the diamond Berkovich indenter to form an indent to an indentation depth in the range from about 50 nm to about 1000 nm (or the entire thickness of the AR coating, whichever is less) and measuring the maximμm hardness from this indentation along the entire indentation depth range or a segment of this indentation depth (e.g., in the range from about 100 nm to about 600 nm, from about 100 nm to about 500 nm, to a depth of 200 nm, etc.), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. As used herein, each of “hardness” and “maximμm hardness” interchangeably refers to a maximμm hardness as measured along a range of indentation depths, and not an average hardness.

Typically, in nanoindentation measurement methods (such as the Berkovich Indenter Hardness Test) of a coating or film that is harder than the underlying substrate, the measured hardness may appear to increase initially due to development of the plastic zone at shallow indentation depths and then increases and reaches a maximμm value or plateau at deeper indentation depths. Thereafter, hardness begins to decrease at even deeper indentation depths due to the effect of the underlying substrate. Where a substrate having an increased hardness compared to the coating is utilized, the same effect can be seen; however, the hardness increases at deeper indentation depths due to the effect of the underlying substrate. The indentation depth range and the hardness values at certain indentation depth range(s) can be selected to identify a particular hardness response of the AR coating and layers thereof, described herein, without the effect of the underlying substrate.

When measuring hardness of the AR coating of the screen protectors and/or electronic devices of the disclosure according to the Berkovich Indenter Hardness Test, the region of permanent deformation (plastic zone) of a material is associated with the hardness of the material. During indentation, an elastic stress field extends well beyond this region of permanent deformation. As indentation depth increases, the apparent hardness and modulus are influenced by stress field interactions with the underlying substrate. The substrate influence on hardness occurs at deeper indentation depths (i.e., typically at depths greater than about 10% of the AR coating or layer thickness). Moreover, a further complication is that the hardness response requires a certain minimum load to develop full plasticity during the indentation process. Prior to that certain minimum load, the hardness shows a generally increasing trend.

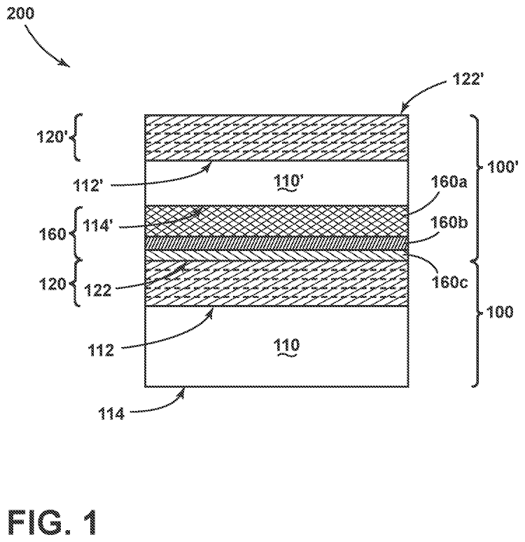

At shallow indentation depths (which also may be characterized as small loads) (e.g., up to about 50 nm), the apparent hardness of a material appears to increase dramatically versus indentation depth. This shallow indentation depth regime does not represent a true metric of hardness, but instead reflects the development of the aforementioned plastic zone, which is related to the finite radius of curvature of the indenter. At intermediate indentation depths, the apparent hardness approaches maximum levels. At deeper indentation depths, the influence of the substrate becomes more pronounced as the indentation depths increase. Hardness may begin to drop dramatically once the indentation depth exceeds about 30% of the outer layered film of the cover articles of the disclosure (e.g., the AR coating 120-120b shown in FIGS. 1-1C and discussed in detailed below).

As used herein, the term “transmittance” is defined as the percentage of incident optical power within a given wavelength range transmitted through a material (e.g., the AR coating and substrate of a screen protector, and an AR coating and substrate of an electronic device, or portions thereof). The term “reflectance” is similarly defined as the percentage of incident optical power within a given wavelength range that is reflected from a material (e.g., the AR coating and substrate of a screen protector, and an AR coating and substrate of an electronic device, or portions thereof). Transmittance and reflectance are measured using a specific linewidth. As used herein, an “average transmittance” refers to the average amount of incident optical power transmitted through a material over a defined wavelength regime. As used herein, an “average reflectance” refers to the average amount of incident optical power reflected by the material. In addition, “average reflectance” can be determined over the visible spectrum, infrared spectrum, or over other wavelength ranges, according to measurement principles understood by those skilled in the field of the disclosure.

As used herein, “photopic reflectance” mimics the response of the human eye by weighting the reflectance or transmittance, respectively, versus wavelength spectrum according to the human eye's sensitivity. Photopic reflectance may also be defined as the luminance, or tri-stimulus Y value of reflected light, according to known conventions such as CIE color space conventions. The “average photopic reflectance”, as used herein, for a wavelength range from 380 nm to 720 nm is defined in the below equation as the spectral reflectance, R(λ) multiplied by the illuminant spectrum, I(λ) and the CIE's color matching function y̅(λ), related to the eye's spectral response given by Equation (1):

$$〈 {R}_{p} 〉 = {\int }_{380 n m}^{720 n m} R ( λ ) \times I ( λ ) \times \overline{y} ( λ ) d λ \qquad ( 1 )$$

In addition, “average reflectance” can be determined over the visible spectrum, or over other wavelength ranges, according to measurement principles understood by those skilled in the field of the disclosure.

Unless otherwise noted, all reflectance values reported or otherwise referenced in this disclosure are associated with testing through the AR coating of the screen protector as disposed on an electronic device with a display (e.g., with its own AR coating) and off of the primary surface of the substrate of the display on which the screen protector is disposed, e.g., a “first-surface” average photopic reflectance, a “first-surface” average reflectance over a specified range of wavelengths, etc.

As used herein, the term “admittance” refers to the optical admittance of the AR coatings of the disclosure. The “admittance” used herein has the same units as electrical admittance, and is defined as the ratio of the total tangential magnetic to total tangential electric field amplitudes at the topmost surface of the topmost layer of the AR coating (e.g., the interface between air and the topmost layer of the AR coating of the screen protector). The optical fields at the wavelength of interest consist of a magnetic and an electric field, and “total” means the sμm of incident and reflected fields. Further, the field amplitudes are represented by complex numbers in general and therefore the “admittance” is also a complex number (see Table 2 below and corresponding description).

As used herein, the term “contrast ratio” refers to the ratio of display luminance of the brightest color to that of the darkest color of a display, including the articles of the disclosure inclusive of screen protectors and electronic devices. Unless otherwise noted, the display luminance and color measurements to calculate contrast ratio take place under ambient lighting as such lighting is the most relevant to what an owner of the article will typically experience with use of the article. Further, the contrast ratio is measured at multiple display luminance values (in units of “nits”). In addition, the contrast ratio can be plotted vs. display luminance so that a given display luminance necessary to obtain a given contrast ratio can be observed. In this context, the display luminance correlates to battery consumption of the article and is meant to describe the light generated by and coming from the display of the article. In particular, the lower the display luminance required to achieve a given contrast ratio, the lower the battery consumption of the article. Unless otherwise noted, all contrast ratio values and measurements in the disclosure are made or otherwise calculated using a Samsung Galaxy S9 mobile phone as the electronic device, Konica Minolta CL-70F lux meter, Photo Research SpectraScan PR-745 spot colorimeter, a Radiant Vision Systems I-Plus image colorimeter, and a neutral density (ND) filter over the lens of the PR-745 colorimeter. Those skilled in the field of the disclosure can employ the foregoing instruments to measure contrast ratio in ambient lighting from the mobile phone with a given screen protector attached to it, e.g., by employing the PR-745 to detect and measure display luminance from the mobile phone.

As used herein, “peel strength” is measured according to the ASTM Standard D3330, as understood and implemented by those skilled in the field of the disclosure against a stainless steel surface with a 180° peel in units of “gf/25 mm”, unless otherwise noted. While it is understood that the adhesives employed in the screen protectors are not applied against a stainless steel surface, the use of a stainless steel surface provides a common reference point for comparison of the peel strength values of the adhesives as used in the articles and screen protectors of this disclosure.

Aspects of the disclosure are directed to screen protectors with antireflective (AR) coatings for electronic device displays that possess their own AR coating and, in some cases, an anti-splinter (AS) film, and articles that include AR display devices and such AR screen protectors. These screen protectors employ an AR coating disposed on a substrate (e.g., a glass substrate, Corning® Gorilla Glass® products, etc.), and an interlayer with an adhesive disposed on the substrate for releasable attachment to an optical coating (e.g., an AR coating) disposed on a glass-containing display of an electronic device. The interlayer can have one or more refractive indices, each ranging from about 1.2 to about 1.6. Further, the interlayer comprises an adhesive and, in some implementations, the interlayer includes an optically clear adhesive (OCA) layer, a polymer-containing layer, and a releasable adhesive layer, each with a uniform or graded refractive index ranging from 1.2 to about 1.6. Additionally, some aspects of the screen protectors are further configured with an AS film (e.g., a polymer-containing layer and an OCA layer) disposed between the interlayer and the screen protector.

The AR screen protectors of the disclosure are tailored to electronic device displays with AR coatings, to ensure that the average photopic reflectance of the combined article (electronic device display+screen protector) is minimized or otherwise not degraded by the presence of the screen protector. More specifically, the interlayers, and AS films (if present), of the screen protectors are tailored with regard to their refractive indices to achieve this optical benefit, e.g., such that each element of the interlayer, and AS film (if present), possesses a refractive index that ranges from about 1.2 to about 1.6. Preferably, the polymer-containing layers of the interlayer and AS film (if present) possess a refractive index between 1.45 and 1.55. For example, the average photopic reflectance of the screen protector, as releasably attached to the display, can be less than 2%, 1.5%, or even 1.2%, for all incident angles from 0° to 30°. As another example, the screen protector can exhibit a contrast ratio (CR) of at least 5 at a display luminance of 200 nits and a CR of at least 10 at a display luminance of 400 nits. Accordingly, the AR screen protectors of the disclosure can be employed by a user to obtain their expected benefits in terms of mechanical properties (e.g., scratch and/or drop resistance) without a detriment to the optical properties (e.g., average photopic reflectance, contrast ratio, etc.) of the electronic display device.

Reference will now be made in detail to various embodiments of screen protectors, electronic devices and articles containing them, examples of which are illustrated in the accompanying drawings. Referring to FIGS. 1-1C, an article 200-200c comprising an electronic device 100-100b and a screen protector 100′-100c′ is depicted, according to one or more embodiments. The electronic device 100-100b can be any display device (e.g., mobile phone, tablet, etc.) with a glass-containing display 110 and an antireflective (AR) coating 120-120b disposed thereon. The screen protector 100′-100c′ comprises a glass-containing substrate 110′ and an AR coating 120′-120b′ disposed thereon. Each of the display 110 and substrate 110′ may include opposing primary surfaces 112, 112′, 114, and 114′, as shown in FIGS. 1-1C, respectively.

The screen protector 100′ (and 100a′, 100b′, 100c′) also includes an interlayer 160, as disposed on the inner primary surface 114′ of the substrate 110′. The interlayer 160 includes an adhesive and can have a physical thickness from about 10 μm to 400 μm or from about 100 μm to 500 μm. In some embodiments, the thickness of the interlayer 160 ranges from about 10 μm to 550 μm, 10 μm to 500 μm, 10 μm to 450 μm, 10 μm to 300 μm, 20 μm to 350 μm, 30 μm to 300 μm, and all thicknesses and thickness sub-ranges between the foregoing. For example, the thickness of the interlayer 160 can be 10 μm, 15 μm, 20 μm, 25 μm, 30 μm, 40 μm, 50 μm, 75 μm, 100 μm, 150 μm, 200 μm, 250 μm, 300 μm, 350 μm, 400 μm, 450 μm, 500 μm, and all thickness values between the foregoing thicknesses.

As also depicted in FIGS. 1-1C, the interlayer 160 of the screen protector 100′ (and 100a′, 100b′ and 100c′) is configured for releasable attachment to the AR coating 120 disposed on the glass-containing display 110 of the electronic device 100. That is, the interlayer 160 can facilitate releasable attachment of the screen protector 100′ from the electronic device 100. In addition, the interlayer 160 has one or more refractive indices, and each refractive index of the interlayer 160 is from about 1.2 to about 1.6, about 1.2 to about 1.5, or about 1.2 to about 1.4. For example, these refractive index values can be about 1.2, 1.25, 1.3, 1.35, 1.4, 1.45, 1.5, 1.55, 1.6, and all refractive index values between these amounts. In some implementations, the interlayer 160 has one or more refractive indices, and each refractive index of the interlayer 160 is within 30%, 20%, or even 10%, of a refractive index of the glass-containing substrate 110′ of the screen protector 100′-100c′ and/or the AR coating 120-120b of the electronic device 100-100b.

In some implementations (e.g., of the articles 200-200c) depicted in FIGS. 1-1C, the interlayer 160 of the screen protector 100′ (and 100a′, 100b′ and 100c′) can comprise an optically clear adhesive (OCA) layer 160a disposed on the inner primary surface 114′ of the glass-containing substrate 110′, a polymer-containing layer 160b disposed on the OCA layer 160a, and a releasable adhesive layer 160c disposed on the polymer-containing layer 160b. In addition, each of the OCA layer 160a, polymer-containing layer 160b, and releasable adhesive layer 160c can have a refractive index from about 1.2 to about 1.6, about 1.2 to about 1.5, or about 1.2 to about 1.4. For example, these refractive index values can be about 1.2, 1.25, 1.3, 1.35, 1.4, 1.45, 1.5, 1.55, 1.6, and all refractive index values between these amounts. In a preferred implementation, the refractive index values of the polymer-containing layer 160b can be from about 1.4 to about 1.6 or about 1.45 to about 1.55, e.g., 1.4, 1.425, 1.45, 1.475, 1.50, 1.525, 1.5, 1.575, 1.6, and all refractive index values between these levels.

With further regard to the interlayer 160, one of its functions is to allow for releasable attachment of the screen protector 100′-100c′ with the electronic device 100-100b (see FIGS. 1-1C). Accordingly, the interlayer 160 comprises an adhesive for this purpose. Recognizing that the screen protector 100′-100c′ includes a glass-containing substrate 110′ and the electronic device 100-100b also contains a glass-containing display 110, the interlayer 160 can have an adhesive system that allows for releasable attachment of these elements, while also being suitable to have adhesion to these glass-containing elements to facilitate the proper functioning of an as-installed screen protector. In one implementation, the interlayer 160 includes an adhesive having a peel strength from 1 to 25 gf/25 mm or from 3 to 5 gf/25 mm. Another approach is for the interlayer 160 to possess an adhesive system that includes an OCA layer 160a, a polymer-containing layer 160b, and a releasable adhesive layer 160c, as depicted in FIGS. 1-1C. In this configuration, the OCA layer 160a should have an adhesive suitable for bonding to the glass-containing substrate 110′ and to the polymer-containing layer 160b with a high peel strength. The polymer-containing layer 160b should be a suitable material with a thickness to serve as an appropriate substrate for the OCA layer 160a. Further, the releasable adhesive layer 160c should be capable of having a strong bond with the polymer-containing layer 160b while at the same time having a relatively low peel strength as bonded to the AR coating 120-120b of the electronic device 100-100b.

According to some implementations of the interlayer 160, the OCA layer 160a can have a physical thickness from 1 μm to 450 μm, 1 μm to 400 μm, 1 μm to 350 μm, 1 μm to 300 μm, 1 μm to 250 μm, 1 μm to 200 μm, 1 μm to 150 μm, 1 μm to 125 μm, from 1 μm to 100 μm, or from 300 μm to 400 μm. For example, the OCA layer 160a can have a thickness of 1 μm, 5 μm, 10 μm, 20 μm, 25 μm, 50 μm, 75 μm, 100 μm, 110 μm, 120 μm, 125 μm, 130 μm, 140 μm, 150 μm, 200 μm, 250 μm, 300 μm, 350 μm, 360 μm, 375 μm, 390 μm, 400 μm, 450 μm, or any thickness values between the foregoing thicknesses. Suitable materials for the OCA layer 160a include any of various adhesive compositions used in the field of this disclosure with a refractive index from about 1.2 to about 1.6, including fluoro-substituted mono-acrylate adhesives, low refractive index ultraviolet (UV) curable hydrogels, nanoporous block copolymers, and nanoporous poly (allylamine hydrochloride)/poly(acrylic acid) (PAH/PAA) polymers. Further, according to some embodiments, the OCA layer 160a exhibits a peel strength of greater than 250 gf/25 mm, 500 gf/25 mm, 750 gf/25 mm, 1000 gf/25 mm, 1250 gf/25 mm, or even 1500 gf/25 mm. For example, the OCA layer 160a can exhibit a peel strength of 250, 300, 400, 500, 600, 700, 750, 800, 900, 1000, 1050, 1100, 1150, 1200, 1250, 1300, 1400, 1500, 1750, 2000 gf/25 mm, and all peel strength values above the foregoing levels.

According to some implementations of the interlayer 160, the polymer-containing layer 160b can have a physical thickness from 5 μm to 200 μm, 8 μm to 200 μm, from 10 μm to 200 μm, from 25 μm to 100 μm, or from 25 μm to 75 μm. For example, the polymer-containing layer 160b can have a thickness of 5 μm, 10 μm, 20 μm, 25 μm, 30 μm, 40 μm, 50 μm, 60 μm, 70 μm, 75 μm, 80 μm, 90 μm, 100 μm, 110 μm, 120 μm, 125 μm, 130 μm, 140 μm, 150 μm, 160 μm, 170 μm, 180 μm, 190 μm, 200 μm, or any thickness values between the foregoing thicknesses. Suitable materials for the polymer-containing layer 160b include polyethylene terephthalate (PET), polytetrafluoroethylene (PTFE), polyvinylidene fluoride (PVDF), ethylene tetrafluoroethylene (ETFE), perfluoroalkoxy alkane (PFA), fluorinated ethylene propylene (FEP), amorphous fluoropolymers, cyclo olefin polymer (COP) (e.g., ZeonorFilm™ from Zeon Corporation), cellulose triacetetate, polyurethanes, and polymethyl methacrylate (PMMA). As noted earlier, the polymer-containing layer 160b can have a refractive index from about 1.2 to about 1.6. In some implementations, the polymer-containing layer 160b can have a refractive index from about 1.4 to about 1.6 or, preferably, from about 1.45 to 1.55 and can comprise, for example, a cyclo olefin polymer (COP), cellulose triacetetate, or a polyurethane.

According to some implementations of the interlayer 160, the releasable adhesive layer 160c can have a physical thickness from 1 μm to 150 μm, 1 μm to 125 μm, from 1 μm to 100 μm, or from 25 μm to 100 μm. For example, the releasable adhesive layer 160c can have a thickness of 1 μm, 5 μm, 10 μm, 20 μm, 25 μm, 30 μm, 40 μm, 50 μm, 60 μm, 70 μm, 75 μm, 80 μm, 90 μm, 100 μm, 110 μm, 120 μm, 125 μm, 130 μm, 140 μm, 150 μm, or any thickness values between the foregoing thicknesses. Suitable materials for the releasable adhesive layer 160c include any of various adhesive compositions used in the field of this disclosure with a refractive index from about 1.2 to about 1.6, including silicone, fluoro-substituted mono-acrylate adhesives, and low refractive index ultraviolet (UV) curable hydrogels nanoporous block copolymers, and nanoporous poly (allylamine hydrochloride)/poly(acrylic acid) (PAH/PAA) polymers. Further, according to some embodiments, the releasable adhesive layer 160c exhibits a peel strength from 1 to 25 gf/25 mm, 1 to 15 gf/25 mm, 1 to 10 gf/25 mm, 2 to 6 gf/25 mm, or 3 to 5 gf/25 mm. For example, the releasable adhesive layer 160c can exhibit a peel strength of 2, 2.5, 3, 3.5, 4, 4.5, 5, 5.5, 6, 7, 8, 9, 10, 11, 12, 13, 14, 15, 16, 17, 18, 19, 20, 21, 22, 23, 24, or 25 gf/25 mm, and all peel strength values between the foregoing levels.

The AR coating 120′-120b′ and AR coating 120-120b are shown in FIGS. 1-1C as being disposed on an outer primary surface 112′, 112 of the glass-containing substrate 110′ and glass-containing display 110, respectively; however, the AR coating 120-120b may also be disposed on the inner primary surface 114 of the display 110, in addition to or instead of being disposed on the outer primary surface 112. The AR coating 120′ (120a′-120b′), 120 (120a-120b) forms an outermost surface 122′, 122, respectively. Further, each of the AR coatings 120a-120b can include a scratch resistant layer 150 (as shown in FIGS. 1A and 1B). In some implementations, the outermost surface 122′, 122 of the AR coating 120′, 120 forms an air-interface and generally defines the edge of AR coating 120′, 120 as well as the edge of the screen protector 100′-100b′ or electronic device 100-100b (e.g., as shown in FIG. 1). In other implementations, an additional coating can be disposed on the outermost surface 122′, 122 of the AR coatings 120′-120b′, and 120-120b. According to some embodiments, the substrate 110′ and/or glass-containing display 110 may be substantially transparent, as described herein.

The AR coating 120′-120b′, 120-120b includes at least one layer of at least one material. The term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed therebetween. In one or more embodiments, a layer may include one or more contiguous and uninterrupted layers and/or one or more discontinuous and interrupted layers (i.e., a layer having different materials formed adjacent to one another). A layer or sub-layers may be formed by any known method in the art, including discrete deposition or continuous deposition processes. In one or more embodiments, the layer may be formed using only continuous deposition processes, or, alternatively, only discrete deposition processes.

The physical thickness of the AR coating 120′-120b′, 120-120b, as depicted in FIGS. 1-1C, may be about 0.25 μm (250 nm) or greater. In some examples, the physical thickness of the AR coating 120′, 120 may be in the range from about 0.25 μm to about 10 μm, from about 0.25 μm to about 7.5 μm, from about 0.25 μm to about 5 μm, from about 0.5 μm to about 5 μm, from about 0.5 μm to about 4 μm, and all thickness values of the AR coating 120′-120b′, 120-120b between these thickness values. In some implementations, the physical thickness of the AR coating 120′-120b′, 120-120b can be 250 nm to 1000 nm, 300 nm to 900 nm, 400 nm to 700 nm, and all thickness values and ranges of thickness values between the foregoing ranges. In other implementations, the physical thickness of the AR coating 120′-120b′, 120-120b can be 250 nm to 450 nm, 750 nm to 3500 nm, 1000 nm to 5000 nm, 1000 nm to 4000 nm, 1500 nm to 3500 nm, 2000 nm to 4000 nm, 2500 nm to 4000 nm, and all thickness values and ranges of thickness values between the foregoing ranges. For example, the physical thickness of AR coating 120′-120b′, 120-120b can be about 0.25 μm, 0.3 μm, 0.4 μm, 0.5 μm, 0.6 μm, 0.7 μm, 0.8 μm, 0.9 μm, 1 μm, 1.25 μm, 1.5 μm, 1.75 μm, 2 μm, 3 μm, 4 μm, 5 μm, 6 μm, 7 μm, 8 μm, 9 μm, 10 μm, and all thickness values between these thicknesses.

As also shown in FIGS. 1A and 1B, the AR coating 120a′-b′, 120a-b includes a plurality of alternating layers (130A, 130B). In one or more embodiments, the AR coating 120a′-b′, 120a-b may include a period comprising two or more layers. In one or more embodiments, the two or more layers may be characterized as having different refractive indices from each another. In one embodiment, the period includes a first low RI layer 130A and a second high RI layer 130B. The difference in the refractive index of the first low RI layer 130A and the second high RI layer 130B may be about 0.01 or greater, about 0.05 or greater, about 0.1 or greater, or even about 0.2 or greater.

As shown in FIGS. 1A and 1B, the AR coating 120a′-b′, 120a-b may include alternating low and high refractive index layers 130A and 130B constituting a plurality of periods. A single period may include a low RI layer 130A and a high RI layer 130B, such that when a plurality of periods are provided, the first low RI layer 130A (designated for illustration as “L”) and the second high RI layer 130B (designated for illustration as “H”) alternate in the following sequence of layers: L/H/L/H or H/L/H/L, such that the low RI layer 130A and the high RI layer 130B appear to alternate along the physical thickness of the AR coating 120a′-b′, 120a-b. In the example depicted in FIG. 1A, each of the AR coating 120a, 120a′ includes two (2) periods, each of which includes a low RI layer 130A and a high RI layer 130B (or scratch resistant layer 150), along with an additional low RI layer 130A (i.e., an outermost low RI layer 130A). In the example depicted in FIG. 1B, the AR coating 120b′, 120b includes six (6) periods, each of which includes a low RI layer 130A and a high RI layer 130B (or scratch resistant layer 150), and an additional low RI layer 130A as the outermost layer.

In some embodiments, the AR coating 120′-120b′, 120-120b may include up to twenty-five (25) periods. For example, the AR coating 120′-120b′, 120-120b, as depicted in FIGS. 1-1B, may include from about 2 to about 25 periods, from about 2 to about 20 periods, from about 2 to about 15 periods, from about 2 to about 10 periods, or any other number of periods within these ranges. For example, the AR coating 120′-120b′, 120-120b may include 2, 3, 4, 5, 6, 7, 8, 9, 10, 11, 12, 13, 14, 15, 16, 17, 18, 19, 20, 21, 22, 23, 24, or 25 periods of alternating low and high RI layers 130A, 130B.

As used herein, the terms “low RI” and “high RI” refer to the relative values for the refractive index of the layers 130A and 130B relative to one another (e.g., low RI<high RI). In one or more embodiments, the term “low RI” when used with the low RI layers 130A, includes a range from about 1.3 to about 1.7 or 1.75. In one or more embodiments, the term “high RI” when used with the high RI layers 130B, includes a range from about 1.7 to about 2.6 (e.g., about 1.85 or greater).

Materials suitable for use in the AR coating 120′-120b′, 120-120b include: SiO₂, Al₂O₃, GeO₂, SiO, AlOₓN_{y}, AlN, SiNₓ, SiOₓN_{y}, SiᵤAlᵥOₓN_{y}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, silicon-containing oxides, silicon-containing nitrides, silicon-containing oxynitrides, polymers, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, other materials cited below as suitable for use in a scratch resistant layer, and other materials known in the art. Some examples of suitable materials for use in the low RI layers 130A include SiO₂, Al₂O₃, GeO₂, SiO, AlOₓN_{y}, SiOₓN_{y}, SiᵤAlᵥOₓN_{y}, MgO, MgAl₂O₄, MgF₂, BaF₂, CaF₂, DyF₃, YbF₃, YF₃, and CeF₃. Some implementations of the low RI layers 130A employ silicon-containing oxides (e.g., SiO, SiO₂, etc.). The nitrogen content of the materials for use in the first low RI layer 130A may be minimized (e.g., in materials such as Al₂O₃ and MgAl₂O₄). Some examples of suitable materials for use in the high RI layers 130B include SiᵤAlᵥOₓN_{y}, Ta₂O₅, Nb₂O₅, AlN, Si₃N₄, AlOₓN_{y}, SiOₓN_{y}, SiNₓ, SiNₓ:H_{y}, HfO₂, TiO₂, ZrO₂, Y₂O₃, Al₂O₃, MoO₃ and diamond-like carbon. Some implementations of the high RI layer(s) 130B employ silicon-containing oxynitrides (e.g., SiOₓN_{y}, SiᵤAlᵥOₓN_{y}, etc.) and/or silicon-containing nitrides (e.g., Si₃N₄, SiNₓ, etc.).

In examples, the high RI layer 130B may also be a high hardness layer or a scratch resistant layer (e.g., scratch resistant layer 150 as shown in FIGS. 1A and 1B), and the high RI materials listed above may also comprise high hardness or scratch resistance. In some implementations, the oxygen content of the materials for the high RI layer 130B and/or the scratch resistant layer 150 may be minimized, especially in SiNₓ or AlNₓ materials. In other implementations, each of the high RI layer 130B and/or the scratch resistant layer 150 comprises SiNₓ or SiOₓN_{y}. In some embodiments, AlOₓN_{y} materials may be considered to be oxygen-doped AlNₓ. That is, these oxygen-doped AlNₓ materials may have an AlNₓ crystal structure (e.g., wurtzite) and need not have an AlON crystal structure.

The hardness of the high RI layers 130B and/or the scratch resistant layer 150 may be characterized specifically. In some embodiments, the maximum hardness of the high RI layers 130B and/or a scratch resistant layer 150, as measured by the Berkovich Indenter Hardness Test at an indentation depth of about 100 nm or greater, may be about 8 GPa or greater, about 10 GPa or greater, about 12 GPa or greater, about 15 GPa or greater, about 18 GPa or greater, or about 20 GPa or greater. In some cases, the high RI layer 130B material may be deposited as a single layer and may be characterized as a scratch resistant layer (e.g., scratch resistant layer 150), and this single layer may have a thickness between about 200 nm and 10000 nm for repeatable hardness determination. In other embodiments in which the high RI layer 130B is deposited as a single layer (e.g., as a scratch resistant layer 150, as depicted in FIGS. 1A and 1B), this layer may have a physical thickness from about 75 nm to about 175 nm, from about 200 nm to about 10000 nm, from about 200 nm to about 5000 nm, from about 300 nm to about 3000 nm, from about 500 nm to about 5000 nm, from about 1000 nm to about 4000 nm, from about 1500 nm to about 4000 nm, from about 1500 nm to about 3000 nm, and all thickness values between these thicknesses.

In one or more embodiments, one or more of the low RI layers 130A and high RI layers 130B of the AR coating 120a′-b′, 120a-b may include a specific physical thickness range. These layer(s) 130A and/or 130B of the AR coating 120a′-b′, 120a-b may include a physical thickness in the range from about 1 nm to about 400 nm, from about 5 nm to about 300 nm, from about 5 nm to about 200 nm, from about 10 nm to about 200 nm, or from about 10 nm to about 250 nm. In some embodiments, all, or a majority, of the layers in the AR coating 120a′-b′, 120a-b may each have a physical thickness in the range from about 1 nm to about 400 nm, from about 5 nm to about 300 nm, from about 5 nm to about 200 nm, from about 10 nm to about 200 nm, or from about 10 nm to about 250 nm. In some embodiments of the article 200, the outermost high refractive index layer 130B of the screen protector 100a′, b′ and/or electronic device 100a, 100b has a physical thickness of greater than 150 nm, greater than 200 nm or even greater than 225 nm. In other implementations of the article 200, greater than 50%, greater than 55% or even greater than 60%, of the outermost physical thickness of the AR coating 120′-120b′, 120-120b comprises high refractive index material, i.e., the material of high RI layers 130B. In further implementations, the outermost high RI layer 130B has a physical thickness that exceeds the physical thickness of the outermost low RI layer 130A, which can enhance hardness values of the AR coating 120′-120b′, 120-120b and its screen protector 100′-100b′ and electronic device 100-100b.

In one or more embodiments, one or more of the layer(s) of the AR coating 120′-120b′, 120-120b may include a specific optical thickness range. As used herein, the term “optical thickness” is determined by the product of the physical thickness (d) and the refractive index (n) of a layer. In one or more embodiments, at least one of the layers (e.g., one or more of the low RI layers 130A and high RI layers 130B) of the AR coating 120′-120b′, 120-120b may include an optical thickness in the range from about 2 nm to about 200 nm, from about 10 nm to about 100 nm, from about 15 nm to about 100 nm, from about 15 to about 500 nm, or from about 15 to about 5000 nm. In some embodiments, all of the layers in the AR coating 120′-120b′, 120-120b may each have an optical thickness in the range from about 2 nm to about 200 nm, from about 10 nm to about 100 nm, from about 15 nm to about 100 nm, from about 15 nm to about 500 nm, or from about 15 nm to about 5000 nm. In some cases, at least one layer of the AR coating 120′-120b′, 120-120b has an optical thickness of about 50 nm or greater. In some cases, each of the low RI layers 130A has an optical thickness in the range from about 2 nm to about 200 nm, from about 10 nm to about 100 nm, from about 15 nm to about 100 nm, from about 15 nm to about 500 nm, or from about 15 nm to about 5000 nm. In other cases, each of the high RI layers 130B has an optical thickness in the range from about 2 nm to about 200 nm, from about 10 nm to about 100 nm, from about 15 nm to about 100 nm, from about 15 nm to about 500 nm, or from about 15 nm to about 5000 nm.

In some embodiments of the article 200, 200a, 200b, 200c, as shown in exemplary form in FIGS. 1-1C, an additional coating (not shown) may be disposed on top of the outermost low RI layer 130A. This additional coating may include a low-friction coating, an oleophobic coating, or an easy-to-clean (ETC) coating. In some embodiments, the outermost low RI layer 130A exhibits a very low thickness (e.g., about 10 nm or less, about 5 nm or less, or about 2 nm or less), which has a minimal influence on the optical performance when added to a substantially thicker outermost high RI layer 130B or scratch resistant layer 150 (e.g., as shown in exemplary form in FIGS. 1A and 1B). The low RI layer 130A having a very low thickness may include SiO₂, an oleophobic or low-friction layer, or a combination of SiO₂ and an oleophobic material. Exemplary low-friction layers may include diamond-like carbon. Such materials (or one or more layers of the AR coating 120′, 120) may exhibit a coefficient of friction less than 0.4, less than 0.3, less than 0.2, or even less than 0.1.

In one or more embodiments, the combined physical thickness of the high RI layer(s) 130B may be characterized. The combined thickness is the calculated combination of the thicknesses of the individual high RI layer(s) 130B in the AR coating 120′-120b′, 120-120b even when there are intervening low RI layer(s) 130A or other layer(s). In some embodiments, the combined physical thickness of the high RI layer(s) 130B, which may also comprise a high-hardness material (e.g., a nitride or an oxynitride material), may be greater than 30% of the total physical thickness of the AR coating 120′-120b′, 120-120b. For example, the combined physical thickness of the high RI layer(s) 130B may be about 25% or greater, 30% or greater, 35% or greater, 40% or greater, about 50% or greater, or even about 60% or greater, of the total physical thickness of the AR coating 120′-120b′, 120-120b.

As noted earlier, the article 200-200cmay include one or more additional coatings disposed on the AR coating 120′-120b′, 120-120b as shown in exemplary form in FIGS. 1-1C. In one or more embodiments, the additional coating may include an easy-to-clean (ETC) coating. An example of a suitable ETC coating is described in U.S. patent application Ser. No. 13/690,904, entitled “Process for Making of Glass Articles with Optical and Easy-to-Clean Coatings,” filed on Nov. 30, 2012, and published as U.S. Patent Application Publication No. 2014/0113083 on Apr. 24, 2014, and the salient portions of this application are incorporated by reference herein in their entirety. The easy-to-clean coating may have a thickness in the range from about 5 nm to about 50 nm and may include known materials such as fluorinated silanes. The easy-to-clean coating may alternately or additionally comprise a low-friction coating or surface treatment. Exemplary low-friction coating materials may include diamond-like carbon, silanes (e.g., fluorosilanes), phosphonates, alkenes, and alkynes. In some embodiments, the easy-to-clean coating may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm or from about 7 nm to about 10 nm, and all ranges and sub-ranges therebetween.

In other embodiments, the additional coating can include a scratch resistant layer or layers (e.g., with a composition similar to scratch resistant layer 150). In some embodiments, the additional coating includes a combination of easy-to-clean material and scratch resistant material. In one example, the combination includes an easy-to-clean material and diamond-like carbon. Such additional coatings may have a thickness in the range from about 5 nm to about 20 nm. The constituents of the additional coating may be provided in separate layers. For example, the diamond-like carbon may be disposed as a first layer and the easy-to clean material can be disposed as a second layer on the first layer of diamond-like carbon. The thicknesses of the first layer and the second layer may be in the ranges provided above for the additional coating. For example, the first layer of diamond-like carbon may have a thickness of about 1 nm to about 20 nm or from about 4 nm to about 15 nm (or more specifically about 10 nm) and the second layer of easy-to-clean material may have a thickness of about 1 nm to about 10 nm (or more specifically about 6 nm). The diamond-like coating may include tetrahedral amorphous carbon (Ta—C), Ta—C:H, and/or a —C—H.

As mentioned herein, the AR coating 120′-120b′, 120-120b depicted in FIGS. 1-1C includes a scratch resistant layer 150, which may be disposed within the AR coating 120′-120b′, 120-120b, directly on the glass-containing substrate 110′ or glass-containing display 110 (not shown) or at the outermost surface 122, 122′ of the AR coating 120-120b′, 120-120b (not shown). In some embodiments, the scratch resistant layer 150 can be disposed between the layers of the AR coating such that portions of the AR coating are above the scratch resistant layer 150 (e.g., an antireflective region) and another portion of the AR coating is below the layer 150 and above the substrate 110′ and/or display 110. In other embodiments (e.g., as shown in FIGS. 1A-1B), a portion of the plurality of low RI and high RI layers 130A, 130B of the AR coating 120a′-b′, 120a-b is between the scratch resistant layer 150 and the substrate 110, and the remaining portion of the AR coating is disposed over the scratch resistant layer 150. In some embodiments, the portion of the AR coating below the layer 150 serves as an optical interference layer or region, which can function to bridge the difference in refractive indices of the substrate 110′ and/or display 110 and the scratch resistant layer 150 and comprises alternating high and low refractive index layers 130B, 130A. The two sections of the AR coating (i.e., an optical interference region disposed between the scratch resistant layer 150 and the substrate 110, and the antireflective region disposed on the scratch resistant layer 150) may have a different thickness from one another or may have essentially the same thickness as one another. The layers of the two sections of the AR coating may be the same in composition, order, thickness and/or arrangement as one another or may differ from one another. In addition, the layers of the two sections of the AR coating may comprise the same number of periods or the number of periods in each of these sections may differ from one another.

Exemplary materials used in the scratch resistant layer 150 (or the scratch resistant layer used as an additional coating, as noted earlier) may include an inorganic carbide, nitride, oxide, diamond-like material, or combination of these. Examples of suitable materials for the scratch resistant layer 150 include metal oxides (e.g., silicon-containing oxides), metal nitrides (e.g., silicon-containing nitrides), metal oxynitride (e.g., silicon-containing oxynitrides), metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch resistant layer 150 or coating may include A1₂O₃, AlN, AlOₓN_{y}, Si₃N₄, SiNₓ, SiOₓN_{y}, SiᵤAlᵥOₓN_{y}, diamond, diamond-like carbon, SiₓC_{y}, SiₓO_{y}C_{z}, ZrO₂, TiOₓN_{y} and combinations thereof. The scratch resistant layer 150 may also comprise nanocomposite materials, or materials with a controlled microstructure to improve hardness, toughness, or abrasion/wear resistance. For example, the scratch resistant layer 150 may comprise nanocrystallites in the size range from about 5 nm to about 30 nm. In embodiments, the scratch resistant layer 150 may comprise transformation-toughened zirconia, partially stabilized zirconia, or zirconia-toughened alumina. In embodiments, the scratch resistant layer 150 exhibits a fracture toughness value greater than about 1 MPa√m and simultaneously exhibits a hardness value greater than about 8 GPa.

The scratch resistant layer 150 may include a single layer (as shown in FIGS. 1A-1B), or multiple sub-layers or single layers that exhibit a refractive index gradient. Where multiple layers are used, such layers form a scratch resistant coating. For example, a scratch resistant layer 150 may include a compositional gradient of SiOₓN_{y} or SiᵤAlᵥOₓN_{y} where the concentration of any one or more of Si, Al, O, and N are varied to increase or decrease the refractive index. The refractive index gradient may also be formed using porosity. Such gradients are more fully described in U.S. patent application Ser. No. 14/262,224, entitled “Scratch-Resistant Articles with a Gradient Layer”, filed on Apr. 25, 2014, and now issued as U.S. Pat. No. 9,703,011 on Jul. 11, 2017, the salient portions of which are hereby incorporated by reference in their entirety.

The scratch resistant layer 150 (e.g., as shown in FIGS. 1A-1B) may have a physical thickness from about 200 nm to about 5000 nm, according to some embodiments. In some implementations, the scratch resistant layer 150 has a physical thickness from about 100 nm to about 10000 nm, from about 200 nm to about 7500 nm, from about 200 nm to about 5000 nm, from about 200 nm to about 3000 nm, from about 500 nm to about 5000 nm, from about 500 nm to about 3000 nm, from about 500 nm to about 2500 nm, from about 1000 nm to about 4000 nm, from about 1500 nm to about 4000 nm, from about 1500 nm to about 3000 nm, from about 1750 nm to about 2250 nm, and all thickness values between these thicknesses. For example, the physical thickness of the scratch resistant layer 150 can be 100 nm, 150 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm, 3000 nm, 3500 nm, 4000 nm, 4500 nm, 5000 nm, 7500 nm, 10000 nm, and all thickness sub-ranges and thickness values between the foregoing thicknesses.

Various exemplary designs of the AR coating 120′-120b′, 120-120b are detailed below in Tables 1A-1E, as designated Exs. 1A-1E. In some implementations of the article 200-200c (see FIGS. 1-1C) and/or screen protector 100′, an AR coating 120a′ (13-layer) such as Ex. 1A or AR coating 120b′ (5-layer) such as Ex. 1B can be employed. In some implementations of the article 200-200c (see FIGS. 1-1C) and/or the electronic device 100, an AR coating 120-120b such as Exs. 1A, 1B or 1C-1E (19 to 23-layer configurations) can be employed.

TABLE 1A
Ex. 1A, 13-Layer AR Coating

| | | Refractive Index | Thickness |
|---|---|---|---|
| Layer | Material | @ 550 nm | (nm) |
| 1 | SiO₂ | 1.46-1.48 | 90.5 |
| 2 | SiOₓN_{y} | 1.94-2.05 | 150.2 |
| 3 | SiO₂ | 1.46-1.48 | 16.6 |
| 4 | SiOₓN_{y} | 1.94-2.05 | 46.3 |
| 5 | SiO₂ | 1.46-1.48 | 9 |
| 6 | SiOₓN_{y} | 1.94-2.05 | 500-2000 |
| 7 | SiO₂ | 1.46-1.48 | 8.71 |
| 8 | SiOₓN_{y} | 1.94-2.05 | 44.88 |
| 9 | SiO₂ | 1.46-1.48 | 30.12 |
| 10 | SiOₓN_{y} | 1.94-2.05 | 26.14 |
| 11 | SiO₂ | 1.46-1.48 | 53.7 |
| 12 | SiOₓN_{y} | 1.94-2.05 | 9.62 |
| 13* | SiO₂ | 1.46-1.48 | 25 |

*Layer 13 is the innermost layer of this AR coating, as disposed over a substrate/display

TABLE 1B
Ex. 1B, 5-Layer AR Coating

| | | Refractive Index | Thickness range |
|---|---|---|---|
| Layer | Material | @ 550 nm | (nm) |
| 1 | SiO₂ | 1.46-1.48 | 81.7-94.6 |
| 2 | SiN_{y} | 2.00-2.06 | 105-158.5 |
| 3 | SiO₂ | 1.46-1.48 | 23.9-37.2 |
| 4 | SiN_{y} | 2.00-2.06 | 21.6-23.1 |
| 5* | SiO₂ | 1.46-1.48 | 24.8-25.0 |

*Layer 5 is the innermost layer of this AR coating, as disposed over a substrate/display

TABLE 1C
Ex. 1C, 19-Layer AR Coating

| | | Refractive Index | Thickness |
|---|---|---|---|
| Layer | Material | @ 550 nm | (nm) |
| 1 | SiO₂ | 1.472 | 102.3 |
| 2 | Si₃N₄ | 2.029 | 152.6 |
| 3 | SiO₂ | 1.472 | 44.65 |
| 4 | Si₃N₄ | 2.029 | 24.9 |
| 5 | SiO₂ | 1.472 | 81.1 |
| 6 | Si₃N₄ | 2.029 | 25.2 |
| 7 | SiO₂ | 1.472 | 46.3 |
| 8 | Si₃N₄ | 2.029 | 38.4 |
| 9 | SiO₂ | 1.472 | 14.6 |
| 10 | SiON | 1.991 | 2100 |
| 11 | SiO₂ | 1.474 | 8 |
| 12 | SiON | 2.003 | 56.1 |
| 13 | SiO₂ | 1.474 | 26.7 |
| 14 | SiON | 2.003 | 39.3 |
| 15 | SiO₂ | 1.474 | 50.8 |
| 16 | SiON | 2.003 | 21.6 |
| 17 | SiO₂ | 1.474 | 67.1 |
| 18 | SiON | 2.003 | 8.1 |
| 19* | SiO₂ | 1.474 | 20 |

*Layer 19 is the innermost layer of this AR coating, as disposed over a substrate/display

TABLE 1D
Ex. 1D, 19-Layer AR Coating

| | | Refractive Index | Thickness |
|---|---|---|---|
| Layer | Material | @ 550 nm | (nm) |
| 1 | SiO₂ | 1.465 | 133 |
| 2 | SiN_{X} | 2.043 | 22.1 |
| 3 | SiO₂ | 1.465 | 47.2 |
| 4 | SiN_{X} | 2.043 | 40.5 |
| 5 | SiO₂ | 1.465 | 25.75 |
| 6 | SiNx | 2.043 | 42.5 |
| 7 | SiO₂ | 1.465 | 8 |
| 8 | SiON | 1.943 | 2050 |
| 9 | SiO₂ | 1.465 | 6.4 |
| 10 | SiON | 1.943 | 62.6 |
| 11 | SiO₂ | 1.465 | 19.6 |
| 12 | SiON | 1.943 | 50.5 |
| 13 | SiO₂ | 1.465 | 38.3 |
| 14 | SiON | 1.943 | 35.5 |
| 15 | SiO₂ | 1.465 | 57.9 |
| 16 | SiON | 1.943 | 21.4 |
| 17 | SiO₂ | 1.465 | 69.2 |
| 18 | SiON | 1.943 | 10 |
| 19* | SiO₂ | 1.465 | 25 |

*Layer 19 is the innermost layer of this AR coating, as disposed over a substrate/display

TABLE 1E
Ex. 1E, 23-Layer AR Coating

| | | Refractive Index | Thickness |
|---|---|---|---|
| Layer | Material | @ 550 nm | (nm) |
| 1 | SiO₂ | 1.476 | 14 |
| 2 | SiON | 1.744 | 76.17 |
| 3 | Si₃N₄ | 2.058 | 66.17 |
| 4 | SiON | 1.744 | 8 |
| 5 | Si₃N₄ | 2.058 | 57.32 |
| 6 | SiON | 1.744 | 37.67 |
| 7 | Si₃N₄ | 2.058 | 15.26 |
| 8 | SiON | 1.744 | 2000 |
| 9 | SiO₂ | 1.476 | 8 |
| 10 | SiON | 1.744 | 76.55 |
| 11 | SiO₂ | 1.476 | 18.28 |
| 12 | SiON | 1.744 | 68.94 |
| 13 | SiO₂ | 1.476 | 31.96 |
| 14 | SiON | 1.744 | 56.68 |
| 15 | SiO₂ | 1.476 | 47.4 |
| 16 | SiON | 1.744 | 44.12 |
| 17 | SiO₂ | 1.476 | 61.66 |
| 18 | SiON | 1.744 | 33.4 |
| 19 | SiO₂ | 1.476 | 70.9 |
| 20 | SiON | 1.744 | 25.34 |
| 21 | SiO₂ | 1.476 | 67.87 |
| 22 | SiON | 1.744 | 16.15 |
| 23* | SiO₂ | 1.476 | 25 |

*Layer 23 is the innermost layer of this AR coating, as disposed over a substrate/display

According to an embodiment, a screen protector 100′-100c′ is provided as depicted in exemplary form in FIGS. 1-1C and configured to be releasably attached to an optical coating (e.g., AR coating 120-120b) disposed on a glass-containing display 110 of an electronic device 100-100b. The screen protector 100′-100c′ includes: a glass-containing substrate 110′ comprising an outer primary surface 112′ and an inner primary surface 114′, wherein the inner primary surface 114′ is opposite from the outer primary surface 112′; an antireflective (AR) coating 120′-120b′ disposed on the outer primary surface 112′ of the glass-containing substrate 110′; and an interlayer 160 disposed on the inner primary surface 114′ of the glass-containing substrate 110′. The interlayer 160 is configured for releasable attachment to the optical coating (e.g., AR coating 120-120b) disposed on the glass-containing display 110 of the electronic device 100-100b. The interlayer 160 comprises an adhesive and has a physical thickness from about 10 μm to 500 μm. The interlayer 160 has one or more refractive indices, and each refractive index of the interlayer 160 is from about 1.2 to about 1.6. Further, an average photopic reflectance of the screen protector 100′-100c′ which is releasably attached to the optical coating (e.g., AR coating 120-120b) of the glass-containing display 110 is less than 2% for all incident angles from 0° to 30°.

According to another embodiment, a screen protector 100′-100c′ is provided as depicted in exemplary form in FIGS. 1-1C that includes: a glass-containing substrate 110′ comprising an outer primary surface 112′ and an inner primary surface 114′, wherein the inner primary surface 114′ is opposite from the outer primary surface 112′; an antireflective (AR) coating 120′-120b′ disposed on the outer primary surface 112′ of the glass-containing substrate 100′; and an interlayer 160 disposed on the inner primary surface 114′ of the glass-containing substrate 110′. The interlayer 160 comprises an optically clear adhesive (OCA) layer 160a disposed on the inner primary surface 114′ of the glass-containing substrate 110′; a polymer-containing layer 160b disposed on the OCA layer 160a; and a releasable adhesive layer 160c disposed on the polymer-containing layer 160b. A total thickness of the OCA layer 160a, the polymer-containing layer 160b and the releasable adhesive layer 160c is from about 10 μm to 500 μm. Further, each of the OCA layer 160a, the polymer-containing layer 160b and the releasable adhesive layer 160c has a refractive index from about 1.2 to about 1.6.

According to a further embodiment, an article 200-200c is provided as depicted in exemplary form in FIGS. 1-1C that includes: an electronic device 100-100b comprising an antireflective (AR) coating 120-120b disposed on a glass-containing display 110; and a screen protector 100′-100c′. One such screen protector 100′ (see FIG. 1) includes: a glass-containing substrate 110′ comprising an outer primary surface 112′ and an inner primary surface 114′, wherein the inner primary surface 114′ is opposite from the outer primary surface 112′; an AR coating 120′-120b′ disposed on the outer primary surface 112′ of the glass-containing substrate 110′; and an interlayer 160 disposed on the inner primary surface 114′ of the glass-containing substrate 110′. The interlayer 160 comprises an optically clear adhesive (OCA) layer 160a disposed on the inner primary surface 114′ of the glass-containing substrate 110′; a polymer-containing layer 160b disposed on the OCA layer 160a; and a releasable adhesive layer 160c disposed on the polymer-containing layer 160b. A total thickness of the OCA layer 160a, the polymer-containing layer 160b and the releasable adhesive layer 160c is from about 10 μm to 500 μm. Further, each of the OCA layer 160a, the polymer-containing layer 160b and the releasable adhesive layer 160c has a refractive index from about 1.2 to about 1.6. Further, the glass-containing substrate 110′ comprises a compressive stress region with a maximum compressive stress (CS) of at least 600 MPa and defined from the outer primary surface 112′ to a depth. In addition, the releasable adhesive layer 160c is configured for releasable attachment to the AR coating 120-120b disposed on the glass-containing display 110 of the electronic device 100-100b.

According to an embodiment, a screen protector 100a′ is provided as depicted in FIG. 1A and configured to be releasably attached to an optical coating (e.g., AR coating 120a) disposed on a glass-containing display 110 of an electronic device 100a. The screen protector 100a′ can include an AR coating 120a′ with a scratch resistant layer 150 having a physical thickness from about 75 nm to about 175 nm, at least one high refractive index (RI) layer 130B, and at least one low refractive index (RI) layer 130A, wherein the scratch resistant layer 150 and each high RI layer 130B comprises a silicon-containing nitride or oxynitride and each low RI layer 130A comprises a silicon-containing oxide, wherein the AR coating 120a′ has a physical thickness from 250 nm to 450 nm, and wherein the screen protector 100a′ exhibits a hardness of 8 GPa or greater as measured on the AR coating 120a′ by a Berkovich Indenter Hardness Test at an indentation depth of about 100 nm or greater. In an implementation of the example depicted in FIG. 1A, each of the AR coating 120a, 120a′ includes two (2) periods, each of which includes a low RI layer 130A and a high RI layer 130B (or scratch resistant layer 150), along with an additional low RI layer 130A (i.e., an outermost low RI layer 130A).

According to an embodiment, a screen protector 100b′ is provided as depicted in FIG. 1B and configured to be releasably attached to an optical coating (e.g., AR coating 120b) disposed on a glass-containing display 110 of an electronic device 100b. The screen protector 100b′ can include an AR coating 120b′ with a scratch resistant layer 150 having a physical thickness from about 300 nm to about 3000 nm, at least one high refractive index (RI) layer 130B, and at least one low refractive index (RI) layer 130a, wherein the scratch resistant layer 150 and each high RI layer 130B comprises a silicon-containing nitride or oxynitride and each low RI layer 130a comprises a silicon-containing oxide, wherein the AR coating 120b′ has a physical thickness from 750 nm to 3500 nm, and wherein the screen protector 100b′ exhibits a hardness of 12 GPa or greater as measured on the AR coating 120b′ by a Berkovich Indenter Hardness Test at an indentation depth of about 100 nm or greater. In an implementation of the example depicted in FIG. 1B, the AR coating 120b′ includes six (6) periods, each of which includes a low RI layer 130A and a high RI layer 130B (or scratch resistant layer 150), and an additional low RI layer 130A as the outermost layer.

According to another embodiment of article 200a, 200b depicted in FIGS. 1A-1B, the AR coating 120a, 120b disposed on the glass-containing display 110 of the electronic device 100a, 100b comprises a scratch resistant layer 150 having a physical thickness from about 300 nm to about 3000 nm, at least one high refractive index (RI) layer 130B, and at least one low refractive index (RI) layer 130A, wherein the scratch resistant layer 150 and each high RI layer 130B comprises a silicon-containing nitride or oxynitride and each low RI layer 130A comprises a silicon-containing oxide, wherein the AR coating 120a, 120b has a physical thickness from 750 nm to 3500 nm, and wherein the electronic device 100a, 100b exhibits a hardness of 12 GPa or greater as measured on the AR coating 120a, 120b by a Berkovich Indenter Hardness Test at an indentation depth of about 100 nm or greater.

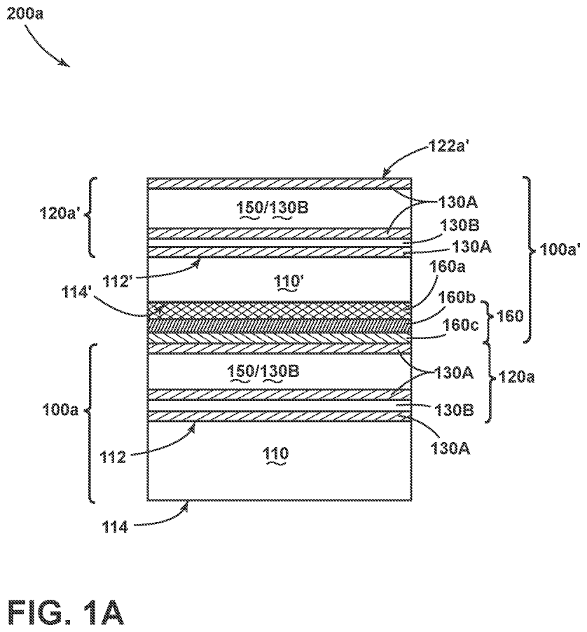

Referring now to FIG. 2A, a schematic is provided of a three-layered material (e.g., a structure that is similar to some implementations of the interlayer 160) with distinct refractive indices. FIG. 2A can be used to illustrate the optimal refractive index of an intermediate medium to minimize total reflectance. There are three layers with distinct refractive indices and two interfaces between them. If the thicknesses of these layers are significantly larger than the coherence length of the light, then the total reflectance is the sum of the Fresnel reflection caused by the discontinuities of the refractive index at the two interfaces. For white light sources, the coherence length is generally less than 1 μm, which is much smaller than the thicknesses of the elements of the interlayer 160 (e.g., OCA layer 160a, polymer-containing layer 160b, releasable adhesive layer 160c) in the screen protector 100′-100c′ (see FIGS. 1-1C).

If all three media in FIG. 2A are homogeneous, i.e., have uniform refractive index throughout the layer, then the total reflectance at normal incidence, when measured in medium 1, is given by the following Fresnel equations given by Equation (2):

$$R = {( \frac{{n}_{1} - {n}_{2}}{{n}_{1} + {n}_{2}} )}^{2} + {( \frac{{n}_{2} - {n}_{3}}{{n}_{2} + {n}_{3}} )}^{2} . \qquad ( 2 )$$

Given the values of n₁ and n₃, the value of n₂ that minimizes the total reflectance and the minimum R are given by the following equations given by Equation (3) below, which is illustrated in FIG. 2B. Indeed, FIG. 2B is a schematic plot of total reflectance vs. refractive index of the second layer of the three-layered material in the schematic of FIG. 2A. Note that the total reflectance does not depend on the thicknesses of any of the layers.

$${n}_{2} = \sqrt{{n}_{1} {n}_{3}} , \qquad ( 3 )$$

$${R}_{min} = 2 {( \frac{{n}_{1} - \sqrt{{n}_{1} {n}_{3}}}{{n}_{1} + \sqrt{{n}_{1} {n}_{3}}} )}^{2} .$$

If a graded-index material can be used for medium 2 where the refractive index changes gradually, either continuously or by small steps, throughout the thickness, then the total reflectance can be lowered to effectively zero (<0.001%). The starting refractive index value of this graded index layer would be n₁ at the medium 1 and medium 2 interface, and the ending refractive index value would be n₃ at the medium 2 and medium 3 interface. In the case of the graded-index layer, the reflectance decreases asymptotically to zero with increasing layer thickness. For layer thicknesses more than 50 μm, the reflectance is small enough and can be considered zero for all practical purposes.

Now consider the structure of the screen protector 100′-100b∝ in FIGS. 1-1B. Using the above method, finding the optimal refractive indices for the elements of the interlayer 160 is equivalent to solving the following optimization problem, as given by Equation (4):

$${arg min}_{{n}_{OCA} , {n}_{polymer} , {n}_{silicone}} R = {( \frac{{n}_{glass} - {n}_{OCA}}{{n}_{glass} + {n}_{OCA}} )}^{2} + {( \frac{{n}_{OCA} - {n}_{polymer}}{{n}_{OCA} + {n}_{polymer}} )}^{2} + {( \frac{{n}_{polymer} - {n}_{silicone}}{{n}_{polymer} + {n}_{silicone}} )}^{2} + {\vert \frac{{n}_{silicone} - {y}_{AR}}{{n}_{silicone} + {y}_{AR}} \vert}^{2} , \qquad ( 4 )$$

$$subject to : {n}_{OCA} \geq 1 , {n}_{polymer} \geq 1 , {n}_{silicone} \geq 1.$$

With further regard to the Equation (4), n_{glass}, n_{OCA}, n_{polymer}, and n_{silicone} are the refractive indices of the glass-containing substrate 110′, OCA layer 160a, polymer-containing layer 160b, and releasable adhesive layer 160c (“silicone”) of the screen protector 100′-100b′ (see FIGS. 1-1B), respectively, and y_{AR} is the admittance of the AR coating 120-120b on the electronic device 100-100b. Note that y_{AR} is not equal to the refractive index of the outermost layer of the AR coating 120-120b in general (e.g., low RI layer 130A) and depends on the coating location, type of coater, coating process, and other factors. The constraints on n_{OCA}, n_{polymer}, and n_{silicone} can be modified based on available material refractive index ranges.

Table 2 below shows the optimization results for select AR coating 120-120b designs (i.e., Exs. 1B-1E, as shown above in Tables 1B-1E) with n_{glass}=1.51 for the glass-containing substrate 110′. In the case of graded-index layers (e.g., layers 160a-160c) for the interlayer 160, the OCA layer 160a would have a refractive index profile starting at n_{glass} at the glass-containing substrate 110′/OCA layer 160a interface and ending at n_{polymer} at the OCA layer 160a/polymer-containing layer 160b interface. Similarly, the releasable adhesive (silicone) layer 160c would have a refractive index profile starting at n_{polymer} at the polymer-containing layer 160b/releasable adhesive (silicone) layer 160c interface and ending at n_{AR} at the releasable adhesive (silicone) layer 160c/AR coating 120-120b interface.

TABLE 2
Summary of Optimized Interlayer Elements for Various
Electronic Device AR Coatings (Exs. 1B-1E)

| AR Coating Design | Ex. 1B | Ex. 1C | Ex. 1D | Ex. 1E |
|---|---|---|---|---|
| Re(y_{AR}) at 550 nm | 1.17275 | 1.15971 | 1.33013 | 1.55044 |
| Im(y_{AR}) at 550 nm | 0.00726 | 0.0622 | 0.0447 | −0.03485 |
| N_{OCA} | 1.42 | 1.41 | 1.46 | 1.52 |
| (OCA layer 160a) | | | | |
| n_{polymer} | 1.33 | 1.32 | 1.41 | 1.53 |
| (polymer layer 160b) | | | | |
| n_{silicone} | 1.25 | 1.24 | 1.37 | 1.54 |
| (release adhesive layer 160c) | | | | |

According to another embodiment, the article 200c includes a screen protector 100c′ (see FIG. 1C) configured for improved mechanical properties (e.g., anti-splinter capability) and optical properties (e.g., improved contrast ratios). In particular, the screen protector 100c′ includes: a glass-containing substrate 110′ comprising an outer primary surface 112′ and an inner primary surface 114′, wherein the inner primary surface 114′ is opposite from the outer primary surface 112′; an AR coating 120′-120b′ disposed on the outer primary surface 112′ of the glass-containing substrate 110′; an anti-splinter (AS) film 180 disposed on the inner primary surface 114′ of the glass-containing substrate 110′; and an interlayer 160 disposed on the AS film 180. In this embodiment, the AS film 180 includes a first optically clear adhesive (OCA) layer 180a disposed on the inner primary surface 114′ and a first polymer-containing layer 180b disposed on the first OCA layer 180a. Further, the interlayer 160 includes a second OCA layer 160a disposed on the first polymer-containing layer 180b; a second polymer-containing layer 160b disposed on the second OCA layer 160a; and a releasable adhesive layer 160c (e.g., silicone) disposed on the second polymer-containing layer 160b. In addition, a total thickness of the second OCA layer 160a, the second polymer-containing layer 160b and the releasable adhesive layer 160c is from about 10 μm to 500 μm (collectively, the physical thickness of the interlayer 160); and a total thickness of the AS film 180 is from about 50 μm to 150 μm. Further, each of the first and second OCA layers 180a and 160a, the first and second polymer-containing layers 180b and 160b and the releasable adhesive layer 160c has a refractive index from about 1.2 to about 1.6. In preferred implementations, the releasable adhesive layer 160c is configured for releasable attachment to the AR coating 120-120b disposed on the glass-containing display 110 of the electronic device 100-100b. In some additional embodiments, the glass-containing substrate 110′ comprises a compressive stress region with a maximum compressive stress (CS) of at least 600 MPa and defined from the outer primary surface 112′ to a depth.

In sμm, the article 200c and screen protector 100c′ (see FIG. 1C) benefits from the presence of the AS film 180, which gives the article an anti-splinter capability. Notably, if the substrate 110′ of the screen protector 100c′ fractures during use, the AS film 180 can retain any shards associated with this fracture. It should also be understood that the AS film 180, as detailed in this section and with its elements described below (i.e., layers 180a and 180b), can optionally be employed in the screen protectors 100′-100b′ to give the articles 200-200b (as depicted in FIGS. 1-1B) an anti-splinter capability.

In some implementations of the screen protector 100c′ depicted in FIG. 1C, the first OCA layer 180a has a physical thickness from about 10 μm to 60 μm, 15 μm to 50 μm, or 25 μm to 40 μm. For example, the first OCA layer 180a can have a thickness of 10 μm, 15 μm, 20 μm, 25 μm, 30 μm, 35 μm, 40 μm, 45 μm, 50 μm, 55 μm, 60 μm, and all thickness values between these values. Preferably, the first OCA layer 180a comprises an adhesive material, including any of the adhesive materials noted earlier in the disclosure that are suitable for OCA layer 160a (see FIGS. 1-1B and corresponding description).

According to some implementations of the screen protector 100c′ depicted in FIG. 1C, the second OCA layer 160a has a physical thickness from about 10 μm to 500 μm, 15 μm to 475 μm, 25 μm to 450 μm, or 50 μm to 400 μm. For example, the second OCA layer 160a can have a thickness of 10 μm, 15 μm, 20 μm, 25 μm, 30 μm, 35 μm, 40 μm, 45 μm, 50 μm, 55 μm, 60 μm, 75 μm, 100 μm, 150 μm, 200 μm, 250 μm, 300 μm, 350 μm, 400 μm, 450 μm, and 500 μm, and all thickness values between these values. Preferably, the second OCA layer 160a comprises an adhesive material, including any of the adhesive materials noted earlier in the disclosure that are suitable for OCA layer 160a (see FIGS. 1-1B and corresponding description).

According to some embodiments of the screen protector 100c′ depicted in FIG. 1C, one or both of the first and second polymer-containing layers 160b and 180b has a physical thickness from about 5 μm to 150 μm, 10 μm to 125 μm, 12 μm to 100 μm, or 25 μm to 75 μm. For example, one or both of the layers 160b and 180b can have a thickness of 5 μm, 10 μm, 12 μm, 15 μm, 20 μm, 25 μm, 30 μm, 35 μm, 40 μm, 45 μm, 50 μm, 55 μm, 60 μm, 70 μm, 75 μm, 100 μm, 125 μm, 150 μm, and all thickness values between these values. The second polymer-containing layer 160b comprises any of the materials noted earlier in the disclosure that are suitable for polymer-containing layer 160b (see FIGS. 1-1B and corresponding description).

As noted earlier, the screen protector 100c′ (see FIG. 1C) can be configured for improved optical properties, including enhanced contrast ratios. In such implementations, one or both of the first and second polymer-containing layers 160b and 180b comprises a cyclo olefin polymer (COP) (e.g., ZeonorFilm™M from Zeon Corporation), a cellulose triacetate, or a polyurethane. Also preferably, one or both of layers 160b and 180b has a refractive index from about 1.4 to 1.6 or, even more preferably, from 1.45 to 1.55. In some additional embodiments of the screen protector 100c′ depicted in FIG. 1C, each of the polymer-containing layers 180b and 160b is one of cyclo olefin polymer (COP), cellulose triacetate, and polyurethane. In some preferred implementations, each of these layers 180b and 160b has a refractive index from about 1.4 to 1.6 or, even more preferably, from 1.45 to 1.55. Advantageously, in such implementations, the polymer-containing layers of the screen protector 100c′, and the article 200c employing it (see FIG. 1C), are of a material (e.g., a COP, a cellulose triacetate or a polyurethane) with a refractive index better-suited to accommodate and match the AR coatings and substrates of both the screen protector 100c′ and the article 200c. In the foregoing implementations, the presence of PET, given its refractive index of ˜1.6, in either or both of the layers 160b and 180b can be detrimental to the overall contrast ratio measured in the article 200c because of buried reflections; consequently, the foregoing implementations employ materials for these layers 160b and 180b that possess a refractive index range better suited to the elements (i.e., the AR coatings, substrate materials, etc.) of the screen protector 100c′ and article 200c.

Referring again to the articles 200-200c, screen protectors 100′-100c′, electronic devices 100-100b, and AR coatings 120′-120b′, 120-120b, as depicted in exemplary form in FIGS. 1-1C, any of these elements may be described in terms of a hardness measured by the Berkovich Indenter Hardness Test. As noted carlier, the Berkovich Indenter Hardness Test includes indenting the outermost surface 122′, 122 of the AR coatings 120′-120b′, 120-120b (see FIGS. 1-1C) or the surface of any one or more of the layers in the AR coating 120′-120b′, 120-120b with the diamond Berkovich indenter to form an indent to an indentation depth in the range from about 50 nm to about 1000 nm (or the entire thickness of the AR coating or layer thereof, whichever is less) or from about 100 nm to about 500 nm, and measuring the maximum hardness from this indentation along the entire indentation depth range or a segment of this indentation depth (e.g., in the range from about 100 nm to about 250 nm, at an indentation depth of 100 nm or greater, etc.).

In some embodiments, articles 200-200c, screen protectors 100′-100c′, electronic devices 100-100b, and AR coatings 120′-120b′, 120-120b (e.g., as depicted in FIGS. 1-1C) may exhibit a hardness of about 8 GPa or greater, about 10 GPa or greater, or about 12 GPa or greater (e.g., about 14 GPa or greater, about 16 GPa or greater, about 18 GPa or greater, or about 20 GPa or greater) when measured at the outermost surface 122′, 122. Such measured hardness values may be exhibited by these features along an indentation depth of about 50 nm or greater, or about 100 nm or greater (e.g., from about 50 nm to about 300 nm, from about 50 nm to about 400 nm, from about 50 nm to about 500 nm, from about 50 nm to about 600 nm, from about 100 nm to about 300 nm, from about 100 nm to about 400 nm, from about 100 nm to about 500 nm, from about 100 nm to about 600 nm, from about 200 nm to about 300 nm, from about 200 nm to about 400 nm, from about 200 nm to about 500 nm, or from about 200 nm to about 600 nm). Such hardness values can also be measured from the outermost surface 122′, 122 of the AR coatings 120′-120b′, 120-120b to a depth of 200 nm. In one or more embodiments, the AR coatings 120′-120b′, 120-120b exhibits a hardness that is greater than the hardness of the glass-containing substrate 110′ and/or glass-containing display 110 (which can be measured on the opposite surface from the outermost surface 122′, 122 (e.g., the inner primary surface 114′, 114)).

According to some implementations of the articles 200-200c, screen protectors 100′-100c′, electronic devices 100-100b, and AR coatings 120′-120b′, 120-120b (e.g., as depicted in FIGS. 1-1C), any of these features can exhibit an average photopic reflectance (1^{st}-surface) of less than about 2%, 1.8%, 1.5%, or even less than 1.2%, as measured at all incident viewing angles from 0° to 30°, or 0° to 15°. For example, any of these features, e.g., the screen protector 100′-100c′ as releasably attached to the AR coating 120-120b of the glass-containing display 110 of the electronic device 100-100b, the article 200-200c, etc., can exhibit an average photopic reflectance of 2%, 1.9%, 1.8%, 1.7%, 1.6%, 1.5%, 1.4%, 1.3%, 1.2%, 1.1%, 1.0%, and all average photopic reflectance values between these levels, at all incident viewing angles from 0° to 30°, or 0° to 15°.

According to some implementations of the screen protectors 100′-100c′, as employed with articles 200-200c, these screen protectors can exhibit a contrast ratio of at least 5, at least 7.5, and/or at least 10 at display luminance values of 200 nits, 300 nits, and 400 nits, respectively. For example, these screen protectors 100′-100c′ can exhibit contrast ratios of at least 5, 6, 7, 8, 9, 10, 11, 12, 13, 14, or 15, at display luminance values of 200 nits and/or contrast ratios of at least 10 at display luminance values of 400 nits. In some embodiments, these screen protectors 100′-100c′ employ polymer-containing layers 160b and/or 180b with a refractive index range from about 1.4 to 1.6 or 1.45 to 1.55 and/or that comprise cyclo olefin polymer (COP), cellulose triacetate, or polyurethanes.

The glass-containing substrate 110′ and glass-containing display 110 may include an inorganic material and may include an amorphous substrate, a crystalline substrate, or a combination thereof. The substrate 110′ and display 110 may be formed from man-made materials and/or naturally occurring materials (e.g., quartz and polymers). For example, in some instances, the substrate 110′ and display 110 may be characterized as organic and may specifically be polymeric. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins.

In some specific embodiments, the glass-containing substrate 110′ and glass-containing display 110 may specifically exclude polymeric, plastic and/or metal materials. The substrate 110′ and display 110 may be characterized as alkali-including substrates (i.e., the substrate 110′ and display 110 includes one or more alkalis). In one or more embodiments, the substrate 110′ and display 110 exhibits a refractive index in the range from about 1.45 to about 1.55. In specific embodiments, the substrate 110′ and display 110 may exhibit an average strain-to-failure at a surface on one or more opposing primary surfaces that is 0.5% or greater, 0.6% or greater, 0.7% or greater, 0.8% or greater, 0.9% or greater, 1% or greater, 1.1% or greater, 1.2% or greater, 1.3% or greater, 1.4% or greater, 1.5% or greater or even 2% or greater, as measured using ball-on-ring testing using at least 5, at least 10, at least 15, or at least 20 samples, as understood by those skilled in the field of this disclosure. In specific embodiments, the substrate 110′ and display 110 may exhibit an average strain-to-failure at its surface on one or more opposing primary surfaces of about 1.2%, about 1.4%, about 1.6%, about 1.8%, about 2.2%, about 2.4%, about 2.6%, about 2.8%, or about 3% or greater.

Suitable substrates for glass-containing substrates 110′ and glass-containing displays 110 may exhibit an elastic modulus (or Young's modulus) in the range from about 30 GPa to about 120 GPa. In some instances, the clastic modulus of the substrate may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween.

In one or more embodiments, the glass-containing substrate 110′ and glass-containing display 110 may be strengthened or non-strengthened. Examples of suitable glasses include soda lime glass, alkali aluminosilicate glass, alkali containing borosilicate glass and alkali aluminoborosilicate glass. In some variants, the glass may be free of lithia. In one or more alternative embodiments, the glass-containing substrate 110′ and glass-containing display 110 may include crystalline substrates such as glass ceramic substrates (which may be strengthened or non-strengthened) or may include a single crystal structure, such as sapphire. In one or more specific embodiments, the substrate 110′ and display 110 includes an amorphous base (e.g., glass) and a crystalline cladding (e.g., sapphire layer, a polycrystalline alumina layer and/or or a spinel (MgAl₂O₄) layer).

In some implementations, the glass-containing substrate 110′ and glass-containing display 110 can include any of the glass substrate compositions (with or without the specified AR coatings) set forth in U.S. Provisional Patent Application No. 63/430,186, entitled “Coated Glass Articles” and filed Dec. 5, 2022, the salient contents of which are hereby incorporated by reference.

The glass-containing substrate 110′ and glass-containing display 110 of one or more embodiments may have a hardness that is less than the hardness of the overall article 200-200b (as measured by the Berkovich Indenter Hardness Test described herein). Unless otherwise noted, the hardness of the substrate 110′ and display 110 is measured using the Berkovich Indenter Hardness Test.

The glass-containing substrate 110′ and glass-containing display 110 may be substantially optically clear, transparent and free from light scattering elements. In such embodiments, the substrate 110′ and display 110 may exhibit an average light transmittance over the optical wavelength regime of about 85% or greater, about 86% or greater, about 87% or greater, about 88% or greater, about 89% or greater, about 90% or greater, about 91% or greater, or about 92% or greater. In some embodiments, these light reflectance and transmittance values may be a total reflectance or total transmittance (taking into account reflectance or transmittance on both primary surfaces 112, 112′, 114, 114′ of the substrate 110′ and display 110) or may be observed on a single side of the substrate 110′ and display 110 (i.e., on the outermost surface 122′, 122 of the AR coating 120′-120b′, 120-120b only, without taking into account the opposite surface). Unless otherwise specified, the average reflectance or transmittance of the substrate 110′ and display 110 alone is measured at an incident illumination angle of 0 degrees relative to the substrate primary surface 112 (however, such measurements may be provided at incident illumination angles of 45 degrees or 60 degrees). The substrate 110′ and display 110 may optionally exhibit a color, such as white, black, red, blue, green, yellow, orange, etc.

Additionally or alternatively, the physical thickness of the glass-containing substrate 110′ and glass-containing display 110 may vary along one or more of its dimensions for aesthetic and/or functional reasons. For example, the edges of the substrate 110′ and display 110 may be thicker as compared to more central regions of the substrate 110′ and display 110. The length, width and physical thickness dimensions of the substrate 110′ and display 110 may also vary according to the application or use of the article 200-200b.

The glass-containing substrate 110′ and glass-containing display 110 may be provided using a variety of different processes. For instance, where the substrate 110′ and display 110 includes an amorphous substrate such as glass, various forming methods can include float glass processes and down-draw processes such as fusion draw and slot draw.

Once formed, a glass-containing substrate 110′ and glass-containing display 110 may be strengthened to form a strengthened substrate. As used herein, the term “strengthened substrate” may refer to a substrate that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

Where the glass-containing substrate 110′ and glass-containing display 110 is chemically strengthened by an ion exchange process, the ions in the surface layer of the substrate are replaced by—or exchanged with—larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate in a salt bath (or baths), use of multiple salt baths, additional steps such as annealing, washing, and the like, are generally determined by the composition of the substrate and the desired compressive stress (CS), depth of compressive stress layer (or depth of layer DOL, or depth of compression DOC) of the substrate that result from the strengthening operation. By way of example, ion exchange of alkali metal-containing glass substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates are immersed in multiple ion exchange baths, with washing and/or annealing steps between immersions, are described in U.S. patent application Ser. No. 12/500,650, filed Jul. 10, 2009, by Douglas C. Allan et al., entitled “Glass with Compressive Surface for Consumer Applications” and claiming priority from U.S. Provisional Patent Application No. 61/079,995, filed Jul. 11, 2008, in which glass substrates are strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass substrates are strengthened by ion exchange in a first bath diluted with an effluent ion, followed by immersion in a second bath having a smaller concentration of the effluent ion than the first bath. The contents of U.S. patent application Ser. No. 12/500,650 and U.S. Pat. No. 8,312,739 are incorporated herein by reference in their entirety.

The degree of chemical strengthening achieved by ion exchange may be quantified based on the parameters of central tension (CT), surface CS, and depth of compression (DOC). Compressive stress (including surface CS) is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. Maximum CT values are measured using a scattered light polariscope (SCALP) technique known in the art. As used herein, DOC means the depth at which the stress in the chemically strengthened alkali aluminosilicate glass article described herein changes from compressive to tensile. DOC may be measured by FSM or SCALP depending on the ion exchange treatment. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles is measured by FSM.

In one embodiment, a glass-containing substrate 110′ and glass-containing display 110 can have a surface CS of 200 MPa or greater, 250 MPa or greater, 300 MPa or greater, e.g., 400 MPa or greater, 450 MPa or greater, 500 MPa or greater, 550 MPa or greater, 600 MPa or greater, 650 MPa or greater, 700 MPa or greater, 750 MPa or greater or 800 MPa or greater. The strengthened substrate may have a DOC (formerly DOL) of 10 μm or greater, 15 μm or greater, 20 μm or greater (e.g., 25 μm, 30 μm, 35 μm, 40 μm, 45 μm, 50 μm or greater) and/or a CT of 10 MPa or greater, 20 MPa or greater, 30 MPa or greater, 40 MPa or greater (e.g., 42 MPa, 45 MPa, or 50 MPa or greater) but less than 100 MPa (e.g., 95, 90, 85, 80, 75, 70, 65, 60, 55 MPa or less). In one or more specific embodiments, the strengthened substrate 110′ and/or display 110 has one or more of the following: a surface CS greater than 500 MPa, a DOC (formerly DOL) greater than 15 μm, and a CT greater than 18 MPa.

Example glasses that may be used in the glass-containing substrate 110′ and glass-containing display 110 may include alkali aluminosilicate glass compositions or alkali aluminoborosilicate glass compositions, though other glass compositions are contemplated. Such glass compositions are capable of being chemically strengthened by an ion exchange process. One example glass composition comprises SiO₂, B₂O₃ and Na₂O, where (SiO₂+B₂O₃)≥66 mol. %, and Na₂O≥9 mol. %. In an embodiment, the glass composition includes at least 6 wt. % aluminum oxide. In a further embodiment, the substrate includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the substrate can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the glass-containing substrate 110′ and glass-containing display 110 comprises: 60-70 mol. % SiO₂; 6-14 mol. % A1₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition suitable for the glass-containing substrate 110′ and glass-containing display 110 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular embodiment, an alkali aluminosilicate glass composition suitable for the glass-containing substrate 110′ and glass-containing display 110 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio (Al₂O₃+B₂O₃)/Σmodifiers (i.e., sμm of modifiers) is greater than 1, where in the ratio the components are expressed in mol. % and the modifiers are alkali metal oxides. This glass composition, in particular embodiments, comprises: 58-72 mol. % SiO₂; 9-17 mol. % A1₂O₃; 2-12 mol. % B₂O₃; 8-16 mol. % Na₂O; and 0-4 mol. % K₂O, wherein the ratio (Al₂O₃+B₂O₃)/Σmodifiers (i.e., sum of modifiers) is greater than 1.

In still another embodiment, the glass-containing substrate 110′ and glass-containing display 110 may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O +B₂O₃+MgO+CaO+SrO>10 mol. %; 5 mol. %≤MgO+CaO+SrO≤8 mol. %; (Na₂O+B₂O₃)−Al₂O₃≤2 mol. %; 2 mol. %≤Na₂O−Al₂O₃≤6 mol. %; and 4 mol. %≤(Na₂O+K₂O)−A1₂O₃≤10 mol. %.

In an alternative embodiment, the glass-containing substrate 110′ and glass-containing display 110 may comprise an alkali aluminosilicate glass composition comprising: 2 mol. % or more of Al₂O₃ and/or ZrO₂, or 4 mol. % or more of Al₂O₃ and/or ZrO₂.

Where the glass-containing substrate 110′ and glass-containing display 110 includes a crystalline substrate, the substrate may include a single crystal, which may include Al₂O₃. Such single crystal substrates are referred to as sapphire. Other suitable materials for a crystalline substrate include polycrystalline alumina layer and/or spinel (MgAl₂O₄).

Optionally, the glass-containing substrate 110′ and glass-containing display 110 may be crystalline and include a glass ceramic substrate, which may be strengthened or non-strengthened. Examples of suitable glass ceramics may include Li₂O-A1₂O₃-SiO₂ system (i.e., LAS-System) glass ceramics, MgO-Al₂O₃-SiO₂ system (i.e., MAS-System) glass ceramics, and/or glass ceramics that include a predominant crystal phase including β-quartz solid solution, β-spodumene ss, cordierite, and lithium disilicate. The glass ceramic substrates may be strengthened using the chemical strengthening processes disclosed herein. In one or more embodiments, MAS-System glass ceramic substrates may be strengthened in Li₂SO₄ molten salt, whereby an exchange of 2Li⁺ for Mg²⁺ can occur.

The glass-containing substrate 110′ and glass-containing display 110 according to one or more embodiments can have a physical thickness ranging from about 50 μm to about 5 mm in various portions of the substrate 110′ and display 110. Example substrate 110′ and display 110 physical thicknesses range from about 50 μm to about 500 μm (e.g., 50, 75, 100, 200, 300, 400 or 500 μm). Further example substrate 110′ and display 110 physical thicknesses can range from about 50 μm to about 5000 μm (e.g., 50, 75, 100, 250, 500, 600, 700, 800, 900, 1000, 1250, 1500, 1750, 2000, 2500, 3000, 3500, 4000, 4500, or 5000 μm). The substrate 110′ and display 110 may have a physical thickness greater than about 1 mm (e.g., about 2, 3, 4, or 5 mm). In one or more specific embodiments, the substrate 110′ and display 110 may have a physical thickness of 2 mm or less, or less than 1 mm. The substrate 110′ and display 110 may be acid polished or otherwise treated to remove or reduce the effect of surface flaws.

Referring again to the articles 200-200c of the disclosure, as depicted in exemplary form in FIGS. 1-1C, the AR coatings 120′-120b′, 120-120b can be formed through various deposition techniques readily understood by those skilled in the field of the disclosure, e.g., reactive sputtering. Further, given the relatively high number of layers and total thickness associated with embodiments of the AR coatings 120′-120b′, 120-120b, a reactive sputtering deposition can be tuned to lower power levels (e.g., 1-2.5 kW in the inductive coupling, reactive plasma zone in a metal-mode sputter drum coater) to minimize substrate temperature to less than 300° C. during deposition. Without being bound by theory, such process adjustments can be useful to retain the maximum level of chemical-strengthened, induced compressive stress in a strengthened glass-containing substrate 110′ and display 110.

The articles 200-200c, as depicted in exemplary form in FIGS. 1-1C and disclosed herein, may be incorporated into another article such as an article with a display (or display articles) (e.g., consumer electronics, including mobile phones, tablets, computers, navigation systems, and the like), architectural articles, transportation articles (e.g., automotive, trains, aircraft, sea craft, etc.), appliance articles, or any article with one or more sensors that require protection (e.g., scratch-resistance, abrasion resistance, hardness, chemical durability or a combination thereof) and optical band-pass filtering capabilities.

Referring now to FIG. 1D, a schematic of an electronic device 100-100b with an AR coating (not shown) is provided, in which the electronic device 100-100b is in the form of a mobile phone device. More specifically, the electronic devices 100-100b include a housing 202 having a front surface 204, a back surface 206, and side surfaces 208, along with electronic components (not shown) that are at least partially inside or entirely within the housing 202. Further, the electronic devices 100-100b include a display 212, which may include a glass-containing display 110 and AR coating 120 (not shown in FIG. 1D; but see FIGS. 1-1C). In addition, the display 210 is at or adjacent to the front surface 204 of the housing 202. Referring now to FIG. 1E, a schematic is provided of an article 200-200c comprising an AR screen protector 100′-100c′ (see also FIGS. 1-1C) and the electronic device 100-100b (see FIG. 1D). As shown in FIGS. 1D and 1E, the screen protector 100′-100c′ is releasably attached to the electronic device 100-100b, with both elements defining the article 200-200c.

### EXAMPLES

Various embodiments of the articles 200-200b, screen protectors 100′-100b′ and electronic devices 100-100b (see FIGS. 1-1B) will be further clarified by the following examples. The following are some examples of calculated photopic reflectance with the optimal interlayer 160 elements (e.g., OCA layer 160a, polymer-containing layer 160b, and releasable adhesive layer 160c) for different combinations of AR coatings employed in the screen protector and for the glass-containing displays of the electronic devices of the disclosure. It should be noted that these calculated photopic reflectance values do not include sub-surface reflections which may be present in varying amounts caused by display electronics or touch sensor layers, that is, the calculated photopic reflectance values quoted here include all of the screen protector layers, interlayers, and all AR coating layers on the glass-containing display (including the interface between AR coating and glass-containing display), but not buried reflections from below the AR coated surface of the glass-containing display, which can vary depending on the details of display electronics (e.g. thin film transistor and other display layers) design. In the following Examples 1-4 and 5-8, the AR coating of the screen protector is either Ex. 1A or Ex. 1B (see Tables 1A & 1B), and the AR coating on the glass-containing display of the electronic device is any one of Exs. 1B-1E (sec Tables 1B-1E).

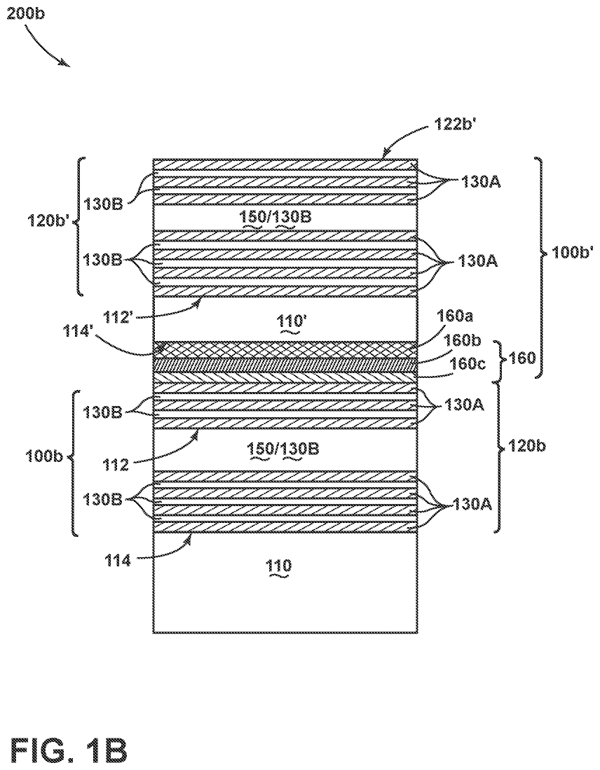

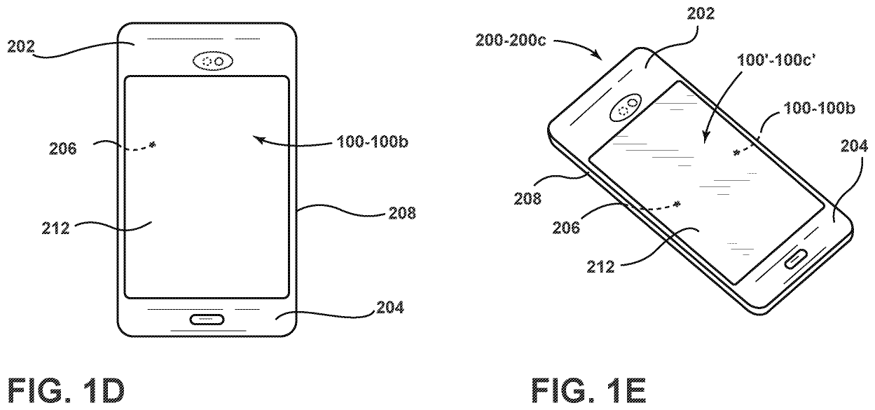

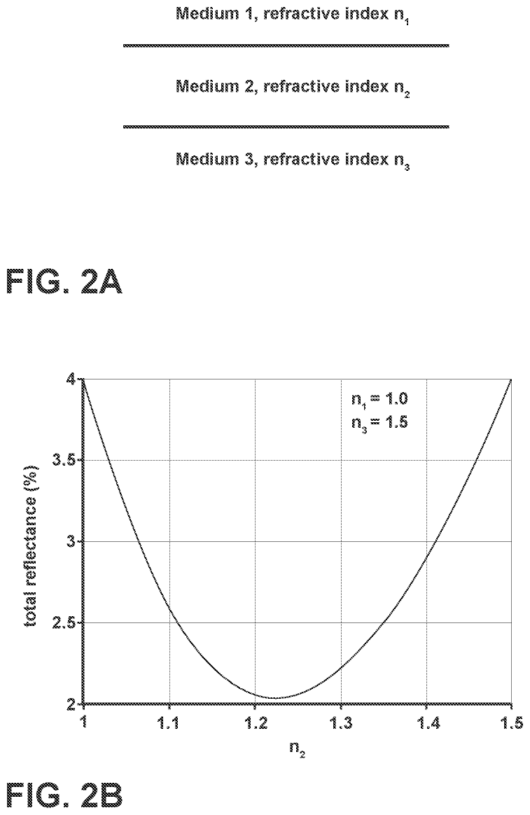

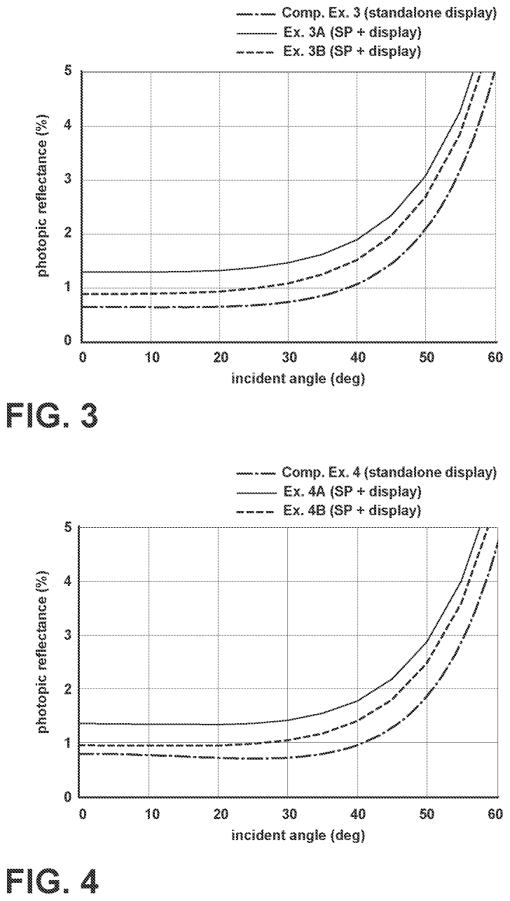

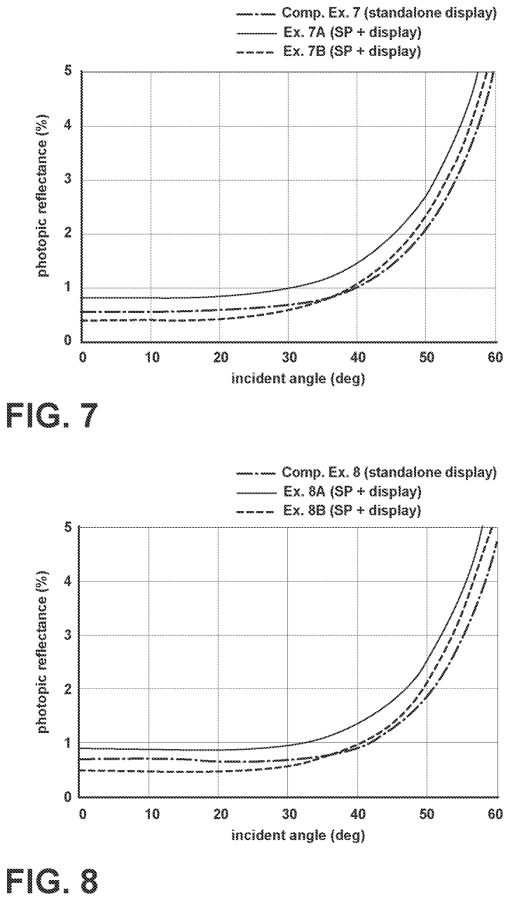

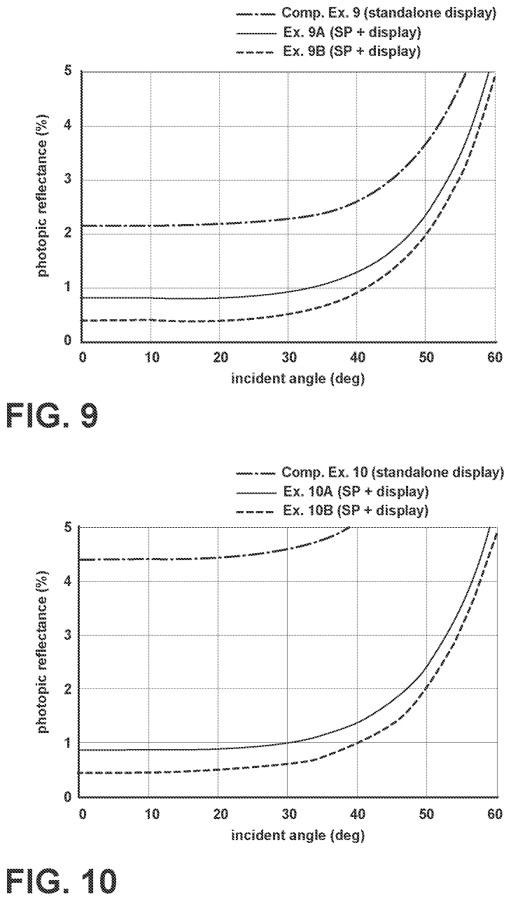

In general, FIGS. 3-6 show the average photopic reflectance of screen protectors with interlayers comprising elements having uniform refractive index values using the optimization results listed in Table 2 (see above) (designated Exs. 3A-3B, 4A-4B, 5A-5B, and 6A-6B) as compared to standalone electronic devices with AR coatings, but no screen protector (designated Comp. Exs. 3-6). FIGS. 7-10 show the average photopic reflectance of exemplary graded index screen protectors which had a linear refractive index gradient for each of the OCA layer and the releasable adhesive (silicone) layer, while using a uniform refractive index for the polymer-containing layer. For the OCA layer in this concept, the graded refractive index profile starts at n_{glass} (=1.51) at the glass-containing display-OCA layer interface and ends at n_{polymer} (=1.65) at the OCA layer-polymer-containing layer interface. For the releasable adhesive (silicone) layer, the graded refractive index profile starts at n_{polymer} (=1.65) at the polymer-containing layer-releasable adhesive (silicone) layer interface and ends at n_{AR}=|y_{AR}| at the releasable adhesive layer (silicone)-AR coating interface (i.e., n=1.1728, 1.1614, 1.3309 and 1.5508 for AR coating designs Exs. 1B, 1C, 1D and 1E, respectively). Further, the polymer-containing layer has a uniform refractive index of n_{polymer} (=1.65). All the graded-index examples described herein utilized the foregoing configuration with interlayers comprising OCA layer and releasable adhesive layer elements having graded refractive index values and polymer-containing layers having a uniform refractive index (designated Exs. 7A-7B, 8A-8B, 9A-9B, and 10A-10B) as compared to standalone electronic devices with AR coatings, but no screen protector (designated Comp. Exs. 7-10). In these calculations, the dispersion of Corning® Gorilla® Glass 3 was used for the glass-containing substrates and glass-containing displays of the screen protectors and electronic devices, respectively. For the case employing interlayers with graded refractive index elements (Examples 5-8), n_{polymer}=1.65 and a uniform refractive index profile was used for the polymer-containing layer of the interlayer. Different index profiles for the elements of the interlayer, such as polynomial or Gaussian, may be used to further improve the reflectance of the article comprising the screen protector and electronic device.

For the case employing interlayers with elements having uniform refractive indices (Examples 1-4), the calculated photopic reflectance at normal incidence can be approximated by the following equation given by Equation (5):

$${R}_{total} = {R}_{t o p} + {R}_{min} . \qquad ( 5 )$$

In Equation (5), Rₜₒₚ is the normal incidence photopic reflectance of the AR coating of the screen protector standalone and Rₘᵢₙ is the minimum from solving the previous optimization problem (see Table 2 and corresponding equations).

### Examples 1-4

In these examples, the photopic reflectance of screen protectors having various AR coating designs with interlayers having elements with uniform refractive indices (e.g., each of OCA layer, polymer-containing layer and releasable adhesive layer have a uniform refractive index), as releasably attached to electronic devices comprising glass-containing displays with various AR coating designs are compared. Further, comparative examples with standalone displays with various AR coating designs were also modeled.

In Example 1, screen protectors (SP) having two AR coating designs (Exs. 1A & 1B) with interlayers having uniform refractive indices were modeled as releasably attached to electronic devices comprising glass-containing displays with an AR coating design (Ex. 1B). Also modeled is a comparative electronic device with a glass-containing display with an AR coating design (Ex. 1B). As such, this example includes three sample configurations: Ex. 3A (SP with Ex. 1A AR coating+display with Ex. 1B AR coating), Ex. 3B (SP with Ex. 1B AR coating+display with Ex. 1B AR coating), and Comp. Ex. 3 (display with Ex. 1B AR coating).

In Example 2, screen protectors (SP) having two AR coating designs (Exs. 1A & 1B) with interlayers having uniform refractive indices were modeled as releasably attached to electronic devices comprising glass-containing displays with an AR coating design (Ex. 1C). Also modeled is a comparative electronic device with a glass-containing display with an AR coating design (Ex. 1C). As such, this example includes three sample configurations: Ex. 4A (SP with Ex. 1A AR coating+display with Ex. 1C AR coating), Ex. 4B (SP with Ex. 1B AR coating+display with Ex. 1C AR coating), and Comp. Ex. 4 (display with Ex. 1C AR coating).

In Example 3, screen protectors (SP) having two AR coating designs (Exs. 1A & 1B) with interlayers having uniform refractive indices were modeled as releasably attached to electronic devices comprising glass-containing displays with an AR coating design (Ex. 1D). Also modeled is a comparative electronic device with a glass-containing display with an AR coating design (Ex. 1D). As such, this example includes three sample configurations: Ex. 5A (SP with Ex. 1A AR coating+display with Ex. 1D AR coating), Ex. 5B (SP with Ex. 1B AR coating+display with Ex. 1D AR coating), and Comp. Ex. 5 (display with Ex. 1D AR coating).

In Example 4, screen protectors (SP) having two AR coating designs (Exs. 1A & 1B) with interlayers having uniform refractive indices were modeled as releasably attached to electronic devices comprising glass-containing displays with an AR coating design (Ex. 1E). Also modeled is a comparative electronic device with a glass-containing display with an AR coating design (Ex. 1E). As such, this example includes three sample configurations: Ex. 6A (SP with Ex. 1A AR coating+display with Ex. 1E AR coating), Ex. 6B (SP with Ex. 1B AR coating+display with Ex. 1E AR coating), and Comp. Ex. 6 (display with Ex. 1E AR coating).

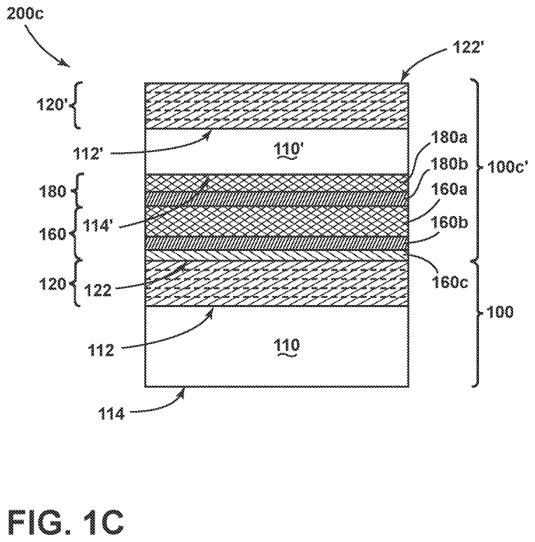

Referring now to FIGS. 3-6, schematic plots are provided of the samples modeled in Examples 1-4 (see above), with each plot displaying the photopic reflectance as a function of incident angle for a particular example (e.g., FIG. 3 corresponds to Example 1, FIG. 4 corresponds to Example 2, and so on). As is evident from FIGS. 3-6, the screen protectors with the Exs. 1A and 1B AR coating designs increase the photopic reflectance for electronic devices with Ex. 1B and Ex. 1C AR coating designs, but decrease the photopic reflectance for electronic devices with the Ex. 1D and Ex. 1E AR coating designs.

### Examples 5-8

In these examples, the photopic reflectance of screen protectors having various AR coating designs with interlayers having elements with graded refractive indices (e.g., each of the OCA layer and releasable adhesive layer have a graded refractive index throughout their respective thicknesses and the polymer-containing layer had a uniform refractive index), as releasably attached to electronic devices comprising glass-containing displays with various AR coating designs are compared. Further, comparative examples with standalone displays with various AR coating designs were also modeled.

In Example 5, screen protectors (SP) having two AR coating designs (Exs. 1A & 1B) with interlayers having graded refractive indices (i.e., the OCA and releasable adhesive layers had graded refractive indices, and the polymer-containing layer had a uniform refractive index) were modeled as releasably attached to electronic devices comprising glass-containing displays with an AR coating design (Ex. 1B). Also modeled is a comparative electronic device with a glass-containing display with an AR coating design (Ex. 1B). As such, this example includes three sample configurations: Ex. 7A (SP with Ex. 1A AR coating+display with Ex. 1B AR coating), Ex. 7B (SP with Ex. 1B AR coating+display with Ex. 1B AR coating), and Comp. Ex. 7 (display with Ex. 1B AR coating).

In Example 6, screen protectors (SP) having two AR coating designs (Exs. 1A & 1B) with interlayers having graded refractive indices were modeled as releasably attached to electronic devices comprising glass-containing displays with an AR coating design (Ex. 1C). Also modeled is a comparative electronic device with a glass-containing display with an AR coating design (Ex. 1C). As such, this example includes three sample configurations: Ex. 8A (SP with Ex. 1A AR coating+display with Ex. 1C AR coating), Ex. 8B (SP with Ex. 1B AR coating+display with Ex. 1C AR coating), and Comp. Ex. 8 (display with Ex. 1C AR coating).

In Example 7, screen protectors (SP) having two AR coating designs (Exs. 1A & 1B) with interlayers having graded refractive indices (i.e., the OCA and releasable adhesive layers had graded refractive indices, and the polymer-containing layer had a uniform refractive index) were modeled as releasably attached to electronic devices comprising glass-containing displays with an AR coating design (Ex. 1D). Also modeled is a comparative electronic device with a glass-containing display with an AR coating design (Ex. 1D). As such, this example includes three sample configurations: Ex. 9A (SP with Ex. 1A AR coating+display with Ex. 1D AR coating), Ex. 9B (SP with Ex. 1B AR coating+display with Ex. 1D AR coating), and Comp. Ex. 9 (display with Ex. 1D AR coating).

In Example 8, screen protectors (SP) having two AR coating designs (Exs. 1A & 1B) with interlayers having graded refractive indices (i.e., the OCA and releasable adhesive layers had graded refractive indices, and the polymer-containing layer had a uniform refractive index) were modeled as releasably attached to electronic devices comprising glass-containing displays with an AR coating design (Ex. 1E). Also modeled is a comparative electronic device with a glass-containing display with an AR coating design (Ex. 1E). As such, this example includes three sample configurations: Ex. 10A (SP with Ex. 1A AR coating+display with Ex. 1E AR coating), Ex. 10B (SP with Ex. 1B AR coating+display with Ex. 1E AR coating), and Comp. Ex. 10 (display with Ex. 1E AR coating).

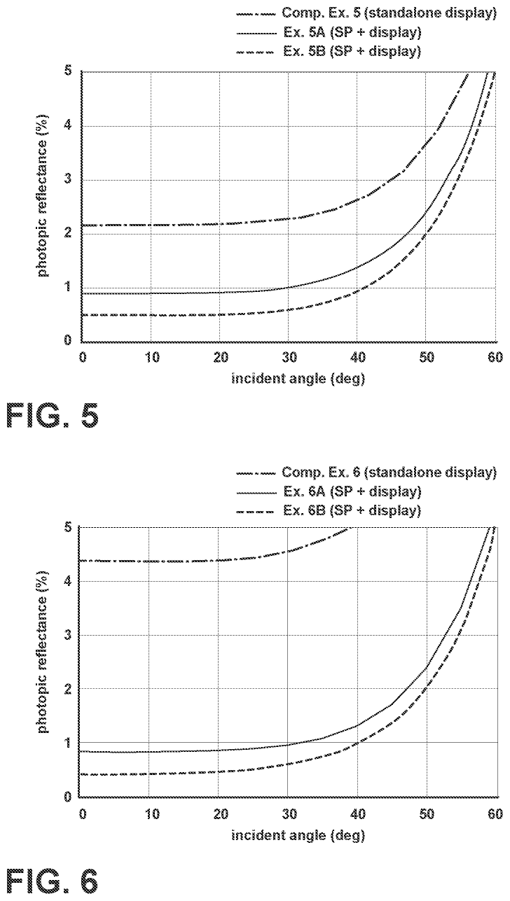

Referring now to FIGS. 7-10, schematic plots are provided of the samples modeled in Examples 5-8 (see above), with each plot displaying the photopic reflectance as a function of incident angle for a particular example (e.g., FIG. 7 corresponds to Example 5, FIG. 8 corresponds to Example 6, and so on). As is evident from FIGS. 7-10, the screen protectors with an Ex. 1A AR coating design having an interlayer with graded refractive index elements (i.e., the OCA and releasable adhesive layers had graded refractive indices, and the polymer-containing layer had a uniform refractive index) on electronic devices with Ex. 1B and Ex. 1C AR coating designs have a much smaller reflectance degradation as compared to the same configurations employing interlayers having elements with uniform refractive index values. As is also evident from FIGS. 7-10, the screen protectors with the Ex. 1B AR coating design having an interlayer with graded refractive index elements improves the photopic reflectance for the electronic devices with each of the four AR coating designs (i.e., Exs. 1B-1E).

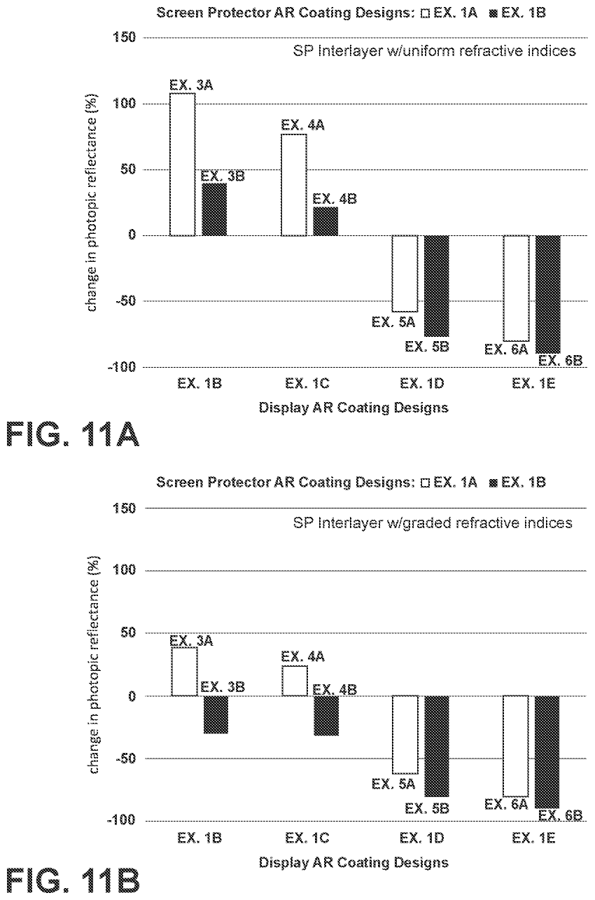

Referring now to FIGS. 11A and 11B, bar chart plots are provided to summarize the photopic reflectance data depicted in FIGS. 3-6 and 7-10, respectively, as viewed at normal incidence (˜0°). Ultimately, FIGS. 11A and 11B show that for the electronic devices employing the Exs. 1D and 1E AR coating designs, the screen protectors employing interlayers with graded refractive index elements (i.e., the OCA and releasable adhesive layers had graded refractive indices, and the polymer-containing layer had a uniform refractive index) do not offer any material advantage over screen protectors employing interlayers with uniform refractive index elements.

### Example 9

For some designs, there are no available materials with the optimal refractive index to use as elements of the interlayer for the screen protector. In this example, the constraint in the optimization problem (see Table 2 and corresponding description above) can be modified to reflect the available refractive index range for materials suitable for use in the interlayer. In particular, the Ex. 1A and Ex. 1B AR coating designs for the screen protector as releasably attached to an electronic display with an Ex. 1C AR coating design and the following constraints given by Equation (6) are modeled:

$$1.4 \leq {n}_{OCA} \leq 1.6 , 1.4 \leq {n}_{p o l y m e r} \leq 1.6 , and 1.4 \leq {n}_{s i l i c o n e} \leq 1.6 . \qquad ( 6 )$$

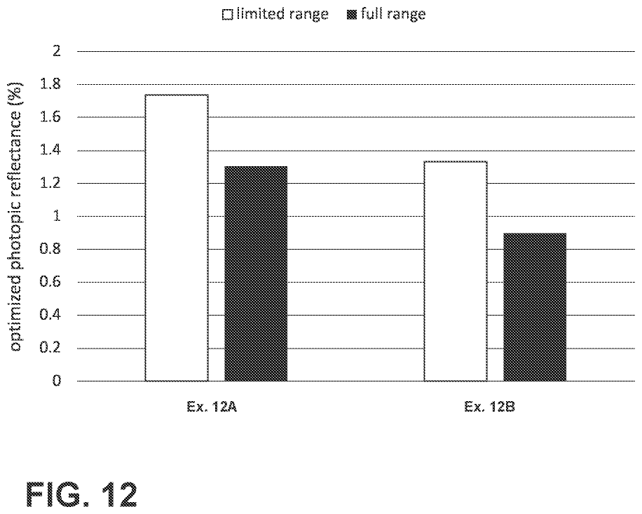

With these constraints, the optimization result is then n_{OCA}=1.47, n_{polymer}=1.43, and n_{silicone}=1.40. FIG. 12 shows the calculated photopic reflectance using these refractive indices (Ex. 12A), as compared to the photopic reflectance obtained in the full-range optimization (see earlier, designated Ex. 12B here). For the screen protectors having both the Ex. 1A and Ex. 1B AR coating designs, the photopic reflectance increases by ˜0.43% with the limited-range refractive indices.

### Example 10

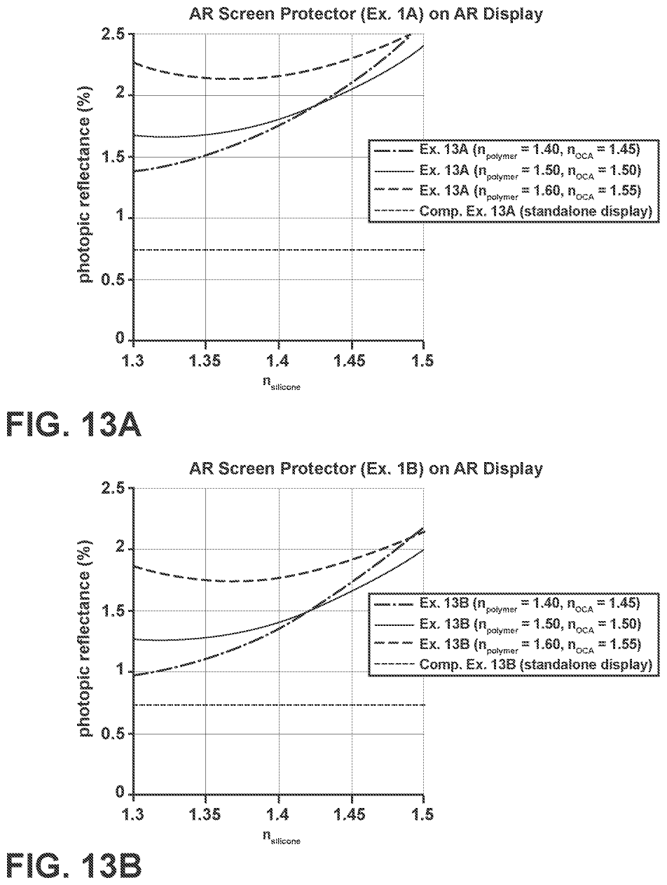

In this example, the photopic reflectance of screen protectors having Exs. 1A and 1B AR coating designs on electronic devices with the Ex. 1C AR coating design on a glass-containing display is modeled. The glass-containing display of this example was Gorilla® Glass Victus® produced by Corning® Incorporated with a composition specified in Table 3 below. Further, the refractive indices of the interlayer elements were varied in this example. In particular, the average photopic reflectance plots in FIGS. 13A and 13B are for combinations employing screen protectors with the Ex. 1A and Ex. 1B AR coating designs (Exs. 13A and 13B), respectively, modeled as a function of the refractive index of the releasable adhesive layer from 1.3 to 1.5 (denoted “n_{silicone}”). In addition, the average photopic reflectance of a standalone display employing the Ex. 1C AR coating is provided as comparison (designated, Comp. Exs. 13A and 13B in FIGS. 13A and 13B, respectively). Various results are provided with different refractive index values of the OCA layer (n=1.45, 1.50, 1.55) and polymer-containing layer (n=1.40, 1.50, and 1.60). Indeed, as noted earlier, practical polymer-containing layers with low refractive index values may include PMMA (n=˜1.45-1.49). Fluorinated polymers (PTFE, PVDF, ETFE, PFA, FEP, amorphous fluoropolymers) can also be considered for the polymer-containing layer with refractive indices as low as 1.4 or even as low as ˜1.3. Fluorinated polymers may require specialized surface treatments to achieve desired adhesion levels.

TABLE 3
Composition of Glass-containing Display

| Composition | Mol % |
|---|---|
| SiO₂ | 58.65 |
| Al₂O₃ | 17.85 |
| P₂O₅ | 1.47 |
| B₂O₃ | 4.22 |
| MgO | 1.19 |
| Li₂O | 7.70 |
| Na₂O | 8.72 |
| K₂O | 0.07 |
| TiO₂ | 0.10 |
| SnO₂ | 0.04 |

As is evident from FIG. 13A, the lowest average photopic reflectance values for a screen protector with the Ex. 1A AR coating design are obtained when the polymer-containing layer and OCA layer having refractive indices of 1.4 and 1.45, respectively, when the releasable adhesive layer has a refractive index from 1.3 to about 1.42. However, when the releasable adhesive layer has a refractive index from about 1.42 to 1.5, it is preferable to employ a polymer-containing layer and OCA layer with refractive indices of 1.50 and 1.50, respectively.

As is also evident from FIG. 13B, the lowest average photopic reflectance values for a screen protector with the Ex. 1B AR coating design are obtained when the polymer-containing layer and OCA layer having refractive indices of 1.4 and 1.45, respectively, when the releasable adhesive layer has a refractive index from 1.3 to about 1.42. However, when the releasable adhesive layer has a refractive index from about 1.42 to 1.5, it is preferable to employ a polymer-containing layer and OCA layer with refractive indices of 1.50 and 1.50, respectively.

Further, and without being bound by theory, it is believed that the modeling results presented in FIGS. 13A and 13B using the Ex. 1A and Ex. 1B AR screen protectors, as described above in this example, are also applicable to an AR display having a glass-containing display with the composition specified below in Tables 4-5. That is, it is believed that the optimized interlayer element refractive indices, as noted above in this example, are also applicable for an AR display having a glass-containing display with the glass composition specified below in Tables 4-5.

TABLE 4
Composition of Glass-containing Display

| Composition | Mol % |
|---|---|
| SiO₂ | 64.85 |
| Al₂O₃ | 15.55 |
| P₂O₅ | 0.86 |
| B₂O₃ | 3.22 |
| MgO | 0.54 |
| CaO | 1.46 |
| SrO | 1.07 |
| ZnO | 0.00 |
| Li₂O | 7.21 |
| Na₂O | 4.78 |
| K₂O | 0.21 |
| TiO₂ | 0.18 |
| SnO₂ | 0.04 |
| Fe₂O₃ | 0.02 |
| ZrO₂ | 0.01 |
| Li₂O/Na₂O | 1.51 |

Table 5 illustrates suitable exemplary compositions which contain the compositional ranges of the glass sheets associated with Tables 3 and 4.

TABLE 5
Suitable Compositions of Substrates

| Composition | Mol % |
|---|---|
| SiO₂ | 50.0-70.0 |
| Al₂O₃ | 10.0-20.0 |
| P₂O₅ | 0.0-2.0 |
| B₂O₃ | 1.0-6.0 |
| Li₂O | 5.0-10.0 |
| Na₂O | 1.0-10.0 |
| K₂O | 0.01-1.0 |

The above glass compositions (Table 3-5) and at least the optical coating (Table 1D) are also described in U.S. Provisional Patent Application No. 63/430,186, filed on Dec. 5, 2022 and entitled “Coated Glass Articles” and U.S. Provisional Patent Application No. 63/452,727, filed on Mar. 17, 2023 and entitled “Coated Glass Articles”, the salient contents of which are hereby incorporated by reference herein.

### Example 11

In this example, the optical property benefits of substituting PET or other relatively high refractive index polymer materials with lower refractive index polymeric materials (e.g., a COP, a cellulose triacetate, or a polyurethane) employed in the AS film and the interlayer of the screen protectors of the disclosure are evaluated. Test coupons consisted of Corning® Gorilla® Glass 3 substrates with an AR coating on one primary surface and a sandwich of acrylic OCA layers and a PET or cyclo olefin (COP) layer (in this example, ZeonorFilm™) on the other primary surface. In particular, one OCA layer was placed in direct contact with the other primary surface of the substrate, followed by the PET or COP layer, and followed by an OCA layer. Each of the OCA layers in each sandwich are of the same material and consist of a commercially available acrylic adhesive material.

In the contrast ratio testing of this example, a Samsung Galaxy S9 phone was employed as the electronic device. In particular, the phone was set to a series of display luminance values and the test coupons were adhered directly to the display of the phone, and then the phone with the coupon was illuminated at 1000 lux. Testing was conducted according to the contrast ratio test method outlined earlier in this disclosure.

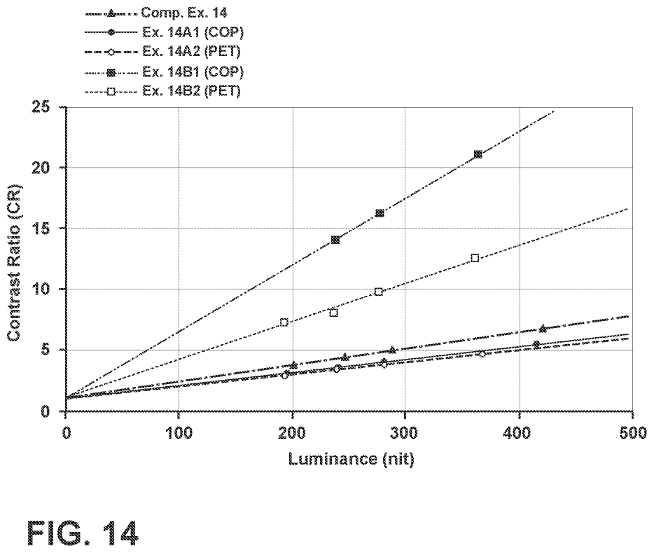

In this example, the following test samples were evaluated: a bare Samsung Galaxy S9 phone without a test coupon (designated “Comp. Ex. 14”); test coupons with an Ex. 1F AR coating design (see Table 6 below) and PET or COP layers between the OCA layers (designated “Ex. 14A1 (COP)” and “Ex. 14A2 (PET)”); and test coupons with an Ex. 1B AR coating design (see Table 1B above) and PET or COP layers between the OCA layers (designated “Ex. 14B1 (COP)” and “Ex. 14B2 (PET)”). Referring now to FIG. 14, a plot is provided of contrast ratio (CR) as a function of display luminance for screen protector samples of this example and the bare phone device control. As is evident from this figure, the screen protector examples employing COP in the OCA layer sandwich (i.e., Exs. 14A1 and 14B1 (COP)) demonstrate higher contrast ratios for a given display luminance than the screen protector samples employing PET in the OCA layer sandwich (i.e., Exs. 14A2 and 14B2 (PET)).

TABLE 6
Ex. 1F, 10-Layer AR Coating

| | | Refractive Index | Thickness |
|---|---|---|---|
| Layer | Material | @ 550 nm | (nm) |
| 1 | SiO₂ | 1.46-1.48 | 45 |
| 2 | AlOₓN_{y} | 1.95-2.00 | 39 |
| 3 | SiO₂ | 1.46-1.48 | 11 |
| 4 | AlOₓN_{y} | 1.95-2.00 | 2000 |
| 5 | SiO₂ | 1.46-1.48 | 9.53 |
| 6 | AlOₓN_{y} | 1.95-2.00 | 41.03 |
| 7 | SiO₂ | 1.46-1.48 | 30.97 |
| 8 | AlOₓN_{y} | 1.95-2.00 | 24.44 |
| 9 | SiO₂ | 1.46-1.48 | 52.79 |
| 10* | AlOₓN_{y} | 1.95-2.00 | 7.84 |

*Layer 10 is the innermost layer of this AR coating, as disposed over a substrate/display

The screen protectors described herein can be used with a variety of electronic devices including but not limited to the exemplary electronic devices having glass displays with optical coatings described in the aforementioned U.S. Provisional Patent Application Nos. 63/430,186 (filed Dec. 5, 2022) and 63/452,727 (filed Mar. 17, 2023), the salient contents of which are hereby incorporated by reference herein.

Further, the various features described in the specification may be combined in any and all combinations, for example, as listed in the following embodiments.
Embodiment 1. A screen protector is provided that is configured to be releasably attached to an optical coating disposed on a glass-containing display of an electronic device. The screen protector includes: a glass-containing substrate comprising an outer primary surface and an inner primary surface, wherein the inner primary surface is opposite from the outer primary surface; an antireflective (AR) coating disposed on the outer primary surface of the glass-containing substrate; and an interlayer disposed on the inner primary surface of the glass-containing substrate. The interlayer is configured for releasable attachment to the optical coating disposed on the glass-containing display of the electronic device. The interlayer comprises an adhesive and has a physical thickness from about 10 μm to 500 μm. The interlayer has one or more refractive indices, and each refractive index of the interlayer is from about 1.2 to about 1.6. Further, an average photopic reflectance of the screen protector which is releasably attached to the optical coating of the glass-containing display is less than 2% for all incident angles from 0° to 30°.
Embodiment 2. The screen protector according to Embodiment 1 is provided, wherein each refractive index of the interlayer is within 30% of a refractive index of the glass-containing substrate or a refractive index of the optical coating.
Embodiment 3. The screen protector according to Embodiment 1 or Embodiment 2 is provided, wherein the adhesive of the interlayer is configured for releasable attachment to the optical coating disposed on the glass-containing display, and wherein the adhesive exhibits a peel strength from 1 to 25 gf/25 mm.
Embodiment 4. The screen protector of any one of Embodiments 1-3 is provided, wherein the glass-containing substrate comprises a compressive stress region with a maximum compressive stress (CS) of at least 600 MPa and defined from the outer primary surface to a depth.
Embodiment 5. The screen protector of any one of Embodiments 1-4 is provided, wherein the average photopic reflectance of the screen protector which is releasably attached to the optical coating of the glass-containing display is less than 1.2% for all incident angles from 0° to 30°.
Embodiment 6. The screen protector of any one of Embodiments 1-5 is provided, wherein the AR coating comprises a scratch resistant layer having a physical thickness from about 75 nm to about 175 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 250 nm to 450 nm, and wherein the screen protector exhibits a hardness of 8 GPa or greater as measured on the AR coating by a Berkovich Indenter Hardness Test at an indentation depth of about 100 nm or greater.
Embodiment 7. The screen protector of any one of Embodiments 1-5 is provided, wherein the AR coating comprises a scratch resistant layer having a physical thickness from about 300 nm to about 3000 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 750 nm to 3500 nm, and wherein the screen protector exhibits a hardness of 12 GPa or greater as measured on the AR coating by a Berkovich Indenter Hardness Test at an indentation depth of about 100 nm or greater.
Embodiment 8. The screen protector of any one of Embodiments 1-7 is provided, further comprising an anti-splinter (AS) film disposed between the interlayer and the glass-containing substrate, with the AS film in direct contact with the interlayer and the inner primary surface of the glass-containing substrate.
Embodiment 9. A screen protector is provided that includes: a glass-containing substrate comprising an outer primary surface and an inner primary surface, wherein the inner primary surface is opposite from the outer primary surface; an antireflective (AR) coating disposed on the outer primary surface of the glass-containing substrate; and an interlayer disposed on the inner primary surface of the glass-containing substrate. The interlayer comprises an optically clear adhesive (OCA) layer disposed on the inner primary surface of the glass-containing substrate; a polymer-containing layer disposed on the OCA layer; and a releasable adhesive layer disposed on the polymer-containing layer. A total physical thickness of the OCA layer, the polymer-containing layer and the releasable adhesive layer is from about 10 μm to 500 μm. Further, each of the OCA layer, the polymer-containing layer and the releasable adhesive layer has a refractive index from about 1.2 to about 1.6.
Embodiment 10. The screen protector of Embodiment 9 is provided, wherein the releasable adhesive layer exhibits a peel strength from 1 to 25 gf/25 mm.
Embodiment 11. The screen protector of Embodiment 9 or Embodiment 10 is provided, wherein the releasable adhesive layer comprises a silicone.
Embodiment 12. The screen protector of any one of Embodiments 9-11 is provided, wherein the OCA layer exhibits a peel strength of greater than 500 gf/25 mm.
Embodiment 13. The screen protector of any one of Embodiments 9-12 is provided, wherein the polymer-containing layer is selected from the group consisting of polyethylene terephthalate (PET), polytetrafluoroethylene (PTFE), polyvinylidene fluoride (PVDF), ethylene tetrafluoroethylene (ETFE), perfluoroalkoxy alkane (PFA), fluorinated ethylene propylene (FEP), amorphous fluoropolymers, a cyclo olefin polymer (COP), cellulose triacetate, polyurethanes, and polymethyl methacrylate (PMMA).
Embodiment 14. The screen protector of any one of Embodiments 9-12 is provided, wherein the polymer-containing layer is a cyclo olefin polymer (COP).
Embodiment 15. The screen protector of any one of Embodiments 9-14 is provided, wherein the OCA layer has a physical thickness from about 1 μm to about 400 μm, the polymer-containing layer has a physical thickness from about 8 μm to about 200 μm, and the releasable adhesive layer has a physical thickness from about 1 μm to about 100 μm.
Embodiment 16. The screen protector of any one of Embodiments 9-15 is provided, wherein the glass-containing substrate comprises a compressive stress region with a maximum compressive stress (CS) of at least 600 MPa and defined from the outer primary surface to a depth.
Embodiment 17. The screen protector of any one of Embodiments 9-16 is provided, wherein an average photopic reflectance of the screen protector, as releasably attached to an optical coating disposed on a glass-containing display of an electronic device, is less than 2% for all incident angles from 0° to 30°.
Embodiment 18. The screen protector of any one of Embodiments 9-16 is provided, wherein an average photopic reflectance of the screen protector, as releasably attached to an optical coating disposed on a glass-containing display of an electronic device, is less than 1.2% for all incident angles from 0° to 30°.
Embodiment 19. The screen protector of any one of Embodiments 9-18 is provided, wherein the AR coating comprises a scratch resistant layer having a physical thickness from about 75 nm to about 175 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 250 nm to 450 nm, and wherein the screen protector exhibits a hardness of 8 GPa or greater as measured on the AR coating by a Berkovich Indenter Hardness Test at an indentation depth of about 100 nm or greater.
Embodiment 20. The screen protector of any one of Embodiments 9-18 is provided, wherein the AR coating comprises a scratch resistant layer having a physical thickness from about 300 nm to about 3000 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 750 nm to 3500 nm, and wherein the screen protector exhibits a hardness of 12 GPa or greater as measured on the AR coating by a Berkovich Indenter Hardness Test at an indentation depth of about 100 nm or greater.
Embodiment 21. The screen protector of any one of Embodiments 9-20 is provided, wherein the releasable adhesive layer is configured to be releasably attached to an optical coating disposed on a glass-containing display of an electronic device.
Embodiment 22. The screen protector of any one of Embodiments 9-21 is provided, further comprising an anti-splinter (AS) film disposed between the interlayer and the glass-containing substrate, with the AS film in direct contact with the interlayer and the inner primary surface of the glass-containing substrate.
Embodiment 23. A screen protector is provided that includes: a glass-containing substrate, an antireflective (AR) coating, an anti-splinter (AS) film, and an interlayer. The glass-containing layer includes an outer primary surface and an inner primary surface. The inner primary surface is opposite from the outer primary surface. The AR coating is disposed on the outer primary surface of the glass-containing substrate. The AS film is disposed on the inner primary surface of the glass-containing substrate. The AS film includes a first optically clear adhesive (OCA) layer disposed on the inner primary surface of the glass-containing substrate, and a first polymer-containing layer disposed on the first OCA layer. Further, the interlayer is disposed on the AS film and includes a second OCA layer disposed on the first polymer-containing layer, a second polymer-containing layer disposed on the second OCA layer, and a releasable adhesive layer disposed on the second polymer-containing layer.
Embodiment 24. The screen protector of Embodiment 23 is provided, wherein the releasable adhesive layer comprises a silicone.
Embodiment 25. The screen protector of Embodiment 23 or Embodiment 24 is provided, wherein each of the first and second polymer-containing layers is selected from the group consisting of a cyclo olefin polymer (COP), cellulose triacetate, and polyurethanes.
Embodiment 26. The screen protector of any one of Embodiments 23-25 is provided, wherein the first OCA layer has a physical thickness from about 15 μm to about 50 μm, the second OCA layer has a physical thickness from about 50 μm to about 400 μm, each of the first and second polymer-containing layers has a physical thickness from about 12 μm to about 100 μm, and the releasable adhesive layer has a physical thickness from about 25 μm to about 100 μm.
Embodiment 27. The screen protector of any one of Embodiments 23-26 is provided, wherein each of the first and second polymer-containing layers has a refractive index from about 1.45 to about 1.55.
Embodiment 28. The screen protector of any one of Embodiments 23-27 is provided, wherein the AR coating comprises a scratch resistant layer having a physical thickness from about 75 nm to about 175 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 250 nm to 450 nm, and wherein the screen protector exhibits a hardness of 8 GPa or greater as measured on the AR coating by a Berkovich Indenter Hardness Test at an indentation depth of about 100 nm or greater. Further, the screen protector exhibits a contrast ratio of at least 5 at a display luminance of 200 nits and a contrast ratio of at least 10 at a display luminance of 400 nits.
Embodiment 29. The screen protector of any one of Embodiments 23-27 is provided, wherein the AR coating comprises a scratch resistant layer having a physical thickness from about 300 nm to about 3000 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 750 nm to 3500 nm, and wherein the screen protector exhibits a hardness of 12 GPa or greater as measured on the AR coating by a Berkovich Indenter Hardness Test at an indentation depth of about 100 nm or greater. Further, the screen protector exhibits a contrast ratio of at least 5 at a display luminance of 200 nits and a contrast ratio of at least 10 at a display luminance of 400 nits.
Embodiment 30. The screen protector of any one of Embodiments 23-29 is provided, wherein a total physical thickness of the interlayer is from about 100 μm to 500 μm and a total physical thickness of the AS film is from about 50 μm to 150 μm, and further wherein each of the first and second polymer-containing layers, the first and second OCA layers, and the releasable adhesive layer has a refractive index from about 1.2 to about 1.6.
Embodiment 31. An article is provided that includes: an electronic device comprising an antireflective (AR) coating disposed on a glass-containing display; and a screen protector. The screen protector includes: a glass-containing substrate comprising an outer primary surface and an inner primary surface, wherein the inner primary surface is opposite from the outer primary surface; an AR coating disposed on the outer primary surface of the glass-containing substrate; and an interlayer disposed on the inner primary surface of the glass-containing substrate. The interlayer comprises an optically clear adhesive (OCA) layer disposed on the inner primary surface of the glass-containing substrate; a polymer-containing layer disposed on the OCA layer; and a releasable adhesive layer disposed on the polymer-containing layer. A total thickness of the OCA layer, the polymer-containing layer and the releasable adhesive layer is from about 10 μm to 500 μm. Further, each of the OCA layer, the polymer-containing layer and the releasable adhesive layer has a refractive index from about 1.2 to about 1.6. Further, the glass-containing substrate comprises a compressive stress region with a maximum compressive stress (CS) of at least 600 MPa and defined from the outer primary surface to a depth. In addition, the releasable adhesive layer is configured for releasable attachment to the AR coating disposed on the glass-containing display of the electronic device.
Embodiment 32. The article of Embodiment 31 is provided, wherein the AR coating disposed on the glass-containing substrate of the screen protector comprises a scratch resistant layer having a physical thickness from about 75 nm to about 175 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating disposed on the glass-containing substrate of the screen protector has a physical thickness from 250 nm to 450 nm, and wherein the screen protector exhibits a hardness of 8 GPa or greater as measured on the AR coating disposed on the glass-containing substrate of the screen protector by a Berkovich Indenter Hardness Test at an indentation depth of about 100 nm or greater.
Embodiment 33. The article of Embodiment 32 is provided, wherein the AR coating disposed on the glass-containing display of the electronic device comprises a scratch resistant layer having a physical thickness from about 300 nm to about 3000 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating disposed on the glass-containing display of the electronic device has a physical thickness from 750 nm to 3500 nm, and wherein the electronic device exhibits a hardness of 12 GPa or greater as measured on the AR coating disposed on the glass-containing display of the electronic device by a Berkovich Indenter Hardness Test at an indentation depth of about 100 nm or greater.
Embodiment 34. The article of Embodiment 31 is provided, wherein the AR coating disposed on the glass-containing substrate of the screen protector comprises a scratch resistant layer having a physical thickness from about 300 nm to about 3000 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating disposed on the glass-containing substrate of the screen protector has a physical thickness from 750 nm to 3500 nm, and wherein the screen protector exhibits a hardness of 12 GPa or greater as measured on the AR coating disposed on the glass-containing substrate of the screen protector by a Berkovich Indenter Hardness Test at an indentation depth of about 100 nm or greater.
Embodiment 35. The article of Embodiment 32 is provided, wherein the AR coating disposed on the glass-containing display of the electronic device comprises a scratch resistant layer having a physical thickness from about 300 nm to about 3000 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating disposed on the glass-containing display of the electronic device has a physical thickness from 750 nm to 3500 nm, and wherein the electronic device exhibits a hardness of 12 GPa or greater as measured on the AR coating disposed on the glass-containing display of the electronic device by a Berkovich Indenter Hardness Test at an indentation depth of about 100 nm or greater.
Embodiment 36. The article of any one of Embodiments 31-35 is provided, wherein the releasable adhesive layer exhibits a peel strength from 1 to 25 gf/25 mm.
Embodiment 37. The article of any one of Embodiments 31-36 is provided, wherein the releasable adhesive layer comprises a silicone.
Embodiment 38. The article of any one of Embodiments 31-37 is provided, wherein the OCA layer exhibits a peel strength of greater than 500 gf/25 mm.
Embodiment 39. The article of any one of Embodiments 31-38 is provided, wherein the polymer-containing layer is selected from the group consisting of polyethylene terephthalate (PET), polytetrafluoroethylene (PTFE), polyvinylidene fluoride (PVDF), ethylene tetrafluoroethylene (ETFE), perfluoroalkoxy alkane (PFA), fluorinated ethylene propylene (FEP), amorphous fluoropolymers, a cyclo olefin polymer (COP), cellulose triacetate, polyurethanes, and polymethyl methacrylate (PMMA).
Embodiment 40. The article of any one of Embodiments 31-39, wherein the polymer-containing layer is a cyclo olefin polymer (COP).
Embodiment 41. The article of any one of Embodiments 31-40 is provided, wherein the OCA layer has a physical thickness from about 1 μm to about 400 μm, the polymer-containing layer has a physical thickness from about 8 μm to about 200 μm, and the releasable adhesive layer has a physical thickness from about 1 μm to about 100 μm.
Embodiment 42. The article of any one of Embodiments 31-41 is provided, wherein an average photopic reflectance of the article is less than 2% for all incident angles from 0° to 30°.
Embodiment 43. The article of any one or Embodiments 31-41 is provided, wherein an average photopic reflectance of the article is less than 1.2% for all incident angles from 0° to 30°.
Embodiment 44. The screen protector of any one of Embodiments 31-43 is provided, further comprising an anti-splinter (AS) film disposed between the interlayer and the glass-containing substrate, with the AS film in direct contact with the interlayer and the inner primary surface of the glass-containing substrate.

What is claimed is:

1. A screen protector configured to be releasably attached to an optical coating disposed on a glass-containing display of an electronic device, the screen protector comprising:
a glass-containing substrate comprising an outer primary surface and an inner primary surface, wherein the inner primary surface is opposite from the outer primary surface;
an antireflective (AR) coating disposed on the outer primary surface of the glass-containing substrate; and
an interlayer disposed on the inner primary surface of the glass-containing substrate,
wherein the interlayer is configured for releasable attachment to the optical coating disposed on the glass-containing display of the electronic device, wherein the interlayer comprises an adhesive and has a physical thickness from about 10 μm to 500 μm,
wherein the interlayer has one or more refractive indices, and each refractive index of the interlayer is from about 1.2 to about 1.6, and
wherein an average photopic reflectance of the screen protector which is releasably attached to the optical coating of the glass-containing display is less than 2% for all incident angles from 0° to 30°.

2. The screen protector of claim 1, wherein each refractive index of the interlayer is within 30% of a refractive index of the glass-containing substrate or a refractive index of the optical coating.

3. The screen protector of claim 1, wherein the adhesive of the interlayer is configured for releasable attachment to the optical coating disposed on the glass-containing display, and wherein the adhesive exhibits a peel strength from 1 to 25 gf/25 mm.

4. The screen protector of claim 1, wherein the glass-containing substrate comprises a compressive stress region with a maximum compressive stress (CS) of at least 600 MPa and defined from the outer primary surface to a depth.

5. The screen protector of claim 1, wherein the average photopic reflectance of the screen protector which is releasably attached to the optical coating of the glass-containing display is less than 1.2% for all incident angles from 0° to 30°.

6. The screen protector of claim 1, wherein the AR coating comprises a scratch resistant layer having a physical thickness from about 75 nm to about 175 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 250 nm to 450 nm, and wherein the screen protector exhibits a hardness of 8 GPa or greater as measured on the AR coating by a Berkovich Indenter Hardness Test at an indentation depth of about 100 nm or greater.

7. The screen protector of claim 1, wherein the AR coating comprises a scratch resistant layer having a physical thickness from about 300 nm to about 3000 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 750 nm to 3500 nm, and wherein the screen protector exhibits a hardness of 12 GPa or greater as measured on the AR coating by a Berkovich Indenter Hardness Test at an indentation depth of about 100 nm or greater.

8. The screen protector of claim 1, further comprising:
an anti-splinter (AS) film disposed between the interlayer and the glass-containing substrate, the AS film in direct contact with the interlayer and the inner primary surface of the glass-containing substrate.

9. A screen protector comprising:
a glass-containing substrate comprising an outer primary surface and an inner primary surface, wherein the inner primary surface is opposite from the outer primary surface;
an antireflective (AR) coating disposed on the outer primary surface of the glass-containing substrate; and
an interlayer disposed on the inner primary surface of the glass-containing substrate, wherein the interlayer comprises:
an optically clear adhesive (OCA) layer disposed on the inner primary surface of the glass-containing substrate;
a polymer-containing layer disposed on the OCA layer; and
a releasable adhesive layer disposed on the polymer-containing layer,
wherein a total physical thickness of the OCA layer, the polymer-containing layer and the releasable adhesive layer is from about 10 μm to 500 μm, and
wherein each of the polymer-containing layer, the OCA layer, and the releasable adhesive layer has a refractive index from about 1.2 to about 1.6.

10. The screen protector of claim 9, wherein the releasable adhesive layer exhibits a peel strength from 1 to 25 gf/25 mm.

11. The screen protector of claim 9, wherein the releasable adhesive layer comprises a silicone.

12. The screen protector of claim 9, wherein the OCA layer exhibits a peel strength of greater than 500 gf/25 mm.

13. The screen protector of claim 9, wherein the polymer-containing layer is selected from the group consisting of polyethylene terephthalate (PET), polytetrafluoroethylene (PTFE), polyvinylidene fluoride (PVDF), ethylene tetrafluoroethylene (ETFE), perfluoroalkoxy alkane (PFA), fluorinated ethylene propylene (FEP), amorphous fluoropolymers, a cyclo olefin polymer (COP), cellulose triacetate, polyurethanes, and polymethyl methacrylate (PMMA).

14. The screen protector of claim 9, wherein the polymer-containing layer is a cyclo olefin polymer (COP).

15. The screen protector of claim 9, wherein the OCA layer has a physical thickness from about 1 μm to about 400 μm, the polymer-containing layer has a physical thickness from about 8 μm to about 200 μm, and the releasable adhesive layer has a physical thickness from about 1 μm to about 100 μm.

16. The screen protector of claim 9, wherein the glass-containing substrate comprises a compressive stress region with a maximum compressive stress (CS) of at least 600 MPa and defined from the outer primary surface to a depth.

17. The screen protector of claim 9, wherein an average photopic reflectance of the screen protector, as releasably attached to an optical coating disposed on a glass-containing display of an electronic device, is less than 2% for all incident angles from 0° to 30°.

18. The screen protector of claim 9, wherein an average photopic reflectance of the screen protector, as releasably attached to an optical coating disposed on a glass-containing display of an electronic device, is less than 1.2% for all incident angles from 0° to 30°.

19. The screen protector of claim 9, wherein the AR coating comprises a scratch resistant layer having a physical thickness from about 75 nm to about 175 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 250 nm to 450 nm, and wherein the screen protector exhibits a hardness of 8 Gpa or greater as measured on the AR coating by a Berkovich Indenter Hardness Test at an indentation depth of about 100 nm or greater.

20. The screen protector of claim 9, wherein the AR coating comprises a scratch resistant layer having a physical thickness from about 300 nm to about 3000 nm, at least one high refractive index (RI) layer, and at least one low refractive index (RI) layer, wherein the scratch resistant layer and each high RI layer comprises a silicon-containing nitride or oxynitride and each low RI layer comprises a silicon-containing oxide, wherein the AR coating has a physical thickness from 750 nm to 3500 nm, and wherein the screen protector exhibits a hardness of 12 Gpa or greater as measured on the AR coating by a Berkovich Indenter Hardness Test at an indentation depth of about 100 nm or greater.

21. The screen protector of claim 9, wherein the releasable adhesive layer is configured to be releasably attached to an optical coating disposed on a glass-containing display of an electronic device.

22. The screen protector of claim 9, further comprising:
an anti-splinter (AS) film disposed between the interlayer and the glass-containing substrate, the AS film in direct contact with the interlayer and the inner primary surface of the glass-containing substrate.

23. A screen protector comprising:
a glass-containing substrate comprising an outer primary surface and an inner primary surface, wherein the inner primary surface is opposite from the outer primary surface;
an antireflective (AR) coating disposed on the outer primary surface of the glass-containing substrate;
an anti-splinter (AS) film disposed on the inner primary surface of the glass-containing substrate, wherein the AS film comprises:
a first optically clear adhesive (OCA) layer disposed on the inner primary surface of the glass-containing substrate; and
a first polymer-containing layer disposed on the first OCA layer; and
an interlayer disposed on the AS film, wherein the interlayer comprises:
a second OCA layer disposed on the first polymer-containing layer;
a second polymer-containing layer disposed on the second OCA layer; and
a releasable adhesive layer disposed on the second polymer-containing layer.

24. An article comprising:
an electronic device comprising an antireflective (AR) coating disposed on a glass-containing display; and
a screen protector, wherein the screen protector comprises:
a glass-containing substrate comprising an outer primary surface and an inner primary surface, wherein the inner primary surface is opposite from the outer primary surface;
an AR coating disposed on the outer primary surface of the glass-containing substrate; and
an interlayer disposed on the inner primary surface of the glass-containing substrate, wherein the interlayer comprises:
an optically clear adhesive (OCA) layer disposed on the inner primary surface of the glass-containing substrate;
a polymer-containing layer disposed on the OCA layer; and
a releasable adhesive layer disposed on the polymer-containing layer,
wherein a total physical thickness of the OCA layer, the polymer-containing layer and the releasable adhesive layer is from about 10 μm to 500 μm,
wherein each of the polymer-containing layer, the OCA layer, and the releasable adhesive layer has a refractive index from about 1.2 to about 1.6,
wherein the glass-containing substrate comprises a compressive stress region with a maximum compressive stress (CS) of at least 600 MPa and defined from the outer primary surface to a depth, and
wherein the releasable adhesive layer is configured for releasable attachment to the AR coating disposed on the glass-containing display of the electronic device.
